(19) United States
(12) Patent Application Publication
(10) Pub. No.: US 2024/0397976 A1
(43) Pub. Date: Dec. 5, 2024

(54) Food Composition and Method of Use

(71) Applicant: Hill's Pet Nutrition, Inc., Overland Park, KS (US)

(72) Inventors: Dennis JEWELL, Lawrence, KS (US); Amber FOLLIS, Topeka, KS (US); Dayakar BADRI, Lawrence, KS (US)

(73) Assignee: Hill's Pet Nutrition, Inc., Overland Park, KS (US)

(21) Appl. No.: 18/736,002

(22) Filed: Jun. 6, 2024

Related U.S. Application Data
(63) Continuation of application No. 15/540,053, filed on Jun. 27, 2017.
(60) Provisional application No. 62/097,169, filed on Dec. 29, 2014.

(51) Int. Cl. A23K 10/30; A23K 40/20; A23K 40/25; A23K 40/30; A23K 50/40; A23K 50/42

(52) U.S. Cl. CPC A23K 10/30; A23K 40/20; A23K 40/25; A23K 40/30; A23K 50/40; A23K 50/42; A23V 2002/00

(57) ABSTRACT

The current invention relates to relates to methods of improving commensals in an animal by feeding the animal with a diet including quinoa grain. The quinoa grain is in an amount effective to increase parameters for commensals such as the percentage of Lactobacillus in total microbiota, the percentage of bifidobacteria in total microbiota, the percentage of Clostridium in total microbiota, and the firmicutes to bacteroidetes ratio. The current invention also relates to pet food compositions that include effective amount of quinoa grain to increase the commensals parameters. In addition, the methods of making such a food compositions are also disclosed.

### CROSS REFERENCE TO RELATED APPLICATIONS

This application is a continuation of U.S. application Ser. No. 15/540,053, filed on Jun. 27, 2017, which is a U.S. National Stage Application of International Application No. PCT/US2015/028118, filed on Apr. 29, 2015, which claims the benefit of, and relies on the filing date of, U.S. Provisional Patent Application No. 62/097,169, filed on Dec. 29, 2014, each of which is herein incorporated by reference in its entirety.

### BACKGROUND

With developing research of food science and animal health, more and more evidence shows that certain microorganisms may provide beneficial effects to animals. In general, commensals are microorganisms that provide health benefits to the host animal. Animals, such as but not limited to dogs and cats, carry trillions of gut microorganisms in their digesting systems, such as but not limited to the intestine and colon. The gut microorganisms, or collectively microbiota, include commensals that provide beneficial effects to animal health.

It is always desirable to improve the commensals in the animal, in some cases by providing different diets to the animals. It is, however, sometimes more difficult to directly add live microorganisms in the diet because food processing may reduce the effectiveness of the microorganisms. Therefore, there is a need to produce animal food that can improve commensals in the microbiota in the animal.

### BRIEF SUMMARY

The current invention relates to a method of altering one or more parameters of commensals in an animal, comprising feeding the animal a diet comprising quinoa grain in an amount effective to increase at least one of the percentage of Lactobacillus in total microbiota, the percentage of bifidobacteria in total microbiota, the percentage of Clostridium in total microbiota, or the firmicutes to bacteroidetes ratio in the animal.

The current invention also relates to a food composition comprising quinoa grain in an amount effective to increase one or more parameters of commensals in an animal when the animal consumes the food composition, wherein the one or more parameters are selected from the group consisting of the percentage of Lactobacillus in total microbiota, the percentage of bifidobacteria in total microbiota, the percentage of Clostridium in total microbiota, and firmicutes to bacteroidetes ratio.

The current invention also relates to a method for making a pet food composition comprising the steps of (a) preconditioning by mixing wet and dry ingredients at elevated temperature to form a dough; (b) extruding the dough at a high temperature and pressure to form an extruded kibble; (c) drying the extruded kibble; and (d) enrobing the dried kibble with topical liquid and/or dry ingredients, wherein quinoa grain is applied to the kibble at step (a) and/or (d), in an amount effective to increase one or more parameters of commensals in an animal when the animal consumes the food composition, wherein the one or more parameters are selected from the group consisting of the percentage of Lactobacillus in total microbiota, the percentage of bifidobacteria in total microbiota, the percentage of Clostridium in total microbiota, and firmicutes to bacteroidetes ratio.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1: Statistical heat map of amino acids.

FIG. 2A-2G: Schematic of tryptophan and polyphenolic compound metabolism, along with statistical heat map and box plots of associated biochemicals.

FIG. 3A-3H: Box plots of secondary bile acids.

FIGS. 4A-4M: Box plots of glucose related metabolites.

FIG. 5A-5C: Statistical heat map of lipid related biochemicals.

FIG. 6A-6I: Box plots of vitamin related biochemicals.

FIG. 7A-7F: Box plots of 20-hydroxyeecdysone, genistate, and 3,4-dihydroxyphenylacetate (DOPAC).

FIG. 8A-8C: Statistical heat map of amino acids and fatty acids.

FIGS. 9 and 10: Box plots of riboflavin and FAD.

FIG. 11A-11C: Statistical heat map of microbiome related metabolites.

FIG. 12: Box plots of 20-hydroxyeecdysone and genistate.

### DETAILED DESCRIPTION

The following description of certain embodiment(s) is merely exemplary in nature and is in no way intended to limit the invention, its application, or uses. As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

As used herein, unless otherwise stated, percentages and amounts in the specification should be understood to refer to percentages by weight. The amounts given are based on the active weight of the material. When referring to percentage of change (e.g. increase) related to a certain parameter, the percentage is calculated based on changed amount divided by the amount indicated as the denominator. For example, if the baseline percentage of Lactobacillus in total microbiota is 12.91% and the measured percentage of Lactobacillus in total microbiota is 17.44% after consumption of a diet comprising effective amount of quinoa grain, the increase would be (17.44−12.91)/12.91=35%.

As used herein, the term “animal” means any non-human organism belonging to the kingdom animalia. The term “pet” means a domestic animal including but not limited to domestic dogs, cats, horses, cows, ferrets, rabbits, pigs, rats, mice, gerbils, hamsters, horses, minks, and the like. Domestic dogs and cats are particular examples of pets. It will be appreciated by one of skill in the art that some pets have different nutritional needs and some pets have similar nutritional needs.

As used herein, the term “commensals” refers to live microorganisms that provide health benefits to their host animal. In some embodiments, “commensals” are the live beneficial microorganisms that are in the host body, e.g. in digestive tracts such as but not limited to intestine and/or colon. Examples of live microorganisms that provide health benefit to their host animals include but are not limited to bacteria.

As used herein, the term “microbiota” refers to the collection of microorganisms that are harbored in the digestive tracts of an animal. The microbiota of an animal includes different microorganisms, such as but not limited to the commensals in the animals digestive tracts.

As used herein, the term “Lactobacillus” refers to microorganisms belonging to the Lactobacillus genus, which are gram-positive facultative anaerobic or microaerophlic rod-shaped bacteria, including species such as but not limited to Lactobacillus acidophilus, Lactobacillus salivarius, and Lactobacillus reuteri. In some embodiments, “Lactobacillus ” refers to commensals in the microbiota that belong to the Lactobacillus genus.

As used herein, the term “bifidobacteria” refers to microorganisms belonging to the Bifidobacterium genus, which are gram-positive, nonmotile, often branched anaerobic bacteria, including species such as but not limited to Bifidobacterium bifidum, Bifidobacterium breve, and Bifidobacterium longum. In some embodiments, “bifidobacteria” refers to commensals in the microbiota that belong to the Bifidobacterium genus.

As used herein, the term “Clostridium” refers to microorganisms belonging to the Clostridium genus, which are gram-positive obligate anaerobes capable of producing endospores, including species such as but not limited to Clostridium botulinum, Clostridium difficile, Clostridium perfringens, Clostridium tetani, and Clostridium sordellii. In some embodiments, “Clostridium” refers to commensals in the microbiota that belong to the Clostridium genus.

As used herein, the term “firmicutes” refers to microorganisms belonging to the Firmicutes phylum, most of which are gram-positive bacteria, including genera such as but not limited to Megasphaera, Pectinatus, Selenomonas and Zymophilus. In some embodiments, “firmicutes” refers to microorganisms in the microbiota that belong to the Firmicutes phylum.

As used herein, the term “bacteroidetes” refers to microorganisms belonging to the Bacteroidetes phylum, most of which are Gram-negative, nonsporeforming, anaerobic, and rod-shaped bacteria, including genus such as but not limited to Bacteroidetes. In some embodiments, “bacteroidetes” refers to microorganisms in the microbiota that belong to the Bacteroidetes phylum.

As used herein, the term “quinoa” refers to an ancient grain crop belonging to the C. quinoa species. In some embodiments, specific quinoa cultivars are used. In specific embodiments, the quinoa cultivar is white. In one specific embodiment, the quinoa grain is not from the cherry vanilla cultivar. In some embodiments, “quinoa grain” refers to the seeds, grinding products or flour derived from the seeds of quinoa.

As used herein, unless otherwise stated for a particular parameter, the term “about” refers to a range that encompasses an industry-acceptable range for inherent variability in analyses or process controls, including sampling error. Consistent with the Model Guidance of AAFCO, inherent variability is not meant to encompass variation associated with sloppy work or deficient procedures, but, rather, to address the inherent variation associated even with good practices and techniques.

As used here, the term “diet” refers to a regulated selection of food and drink for an animal. A diet may comprise a fixed or varied combination or food and/or drink compositions. The diet of the present invention may comprise the food composition of the present invention. The food composition of the present invention may comprise the ingredients and component of the diet herein disclosed.

Food compositions can be provided to an animal, such as but not limited to a pet, in the form of pet food. A variety of commonly known types of pet foods are available to pet owners. The selection of pet food includes but is not limited to wet pet food, semi-moist pet food, dry pet food and pet treats. Wet pet food generally has a moisture content greater than about 65%. Semi-moist pet food typically has a moisture content between about 20% and about 65% and may include humectants, potassium sorbate, and other ingredients to prevent microbial growth (bacteria and mold). Dry pet food such as but not limited to food kibbles generally has a moisture content below about 15%. Pet treats typically may be semi-moist, chewable treats; dry treats in any number of forms; chewable bones or baked, extruded or stamped treats; confection treats; or other kinds of treats as is known to one skilled in the art.

As used herein, the term “kibble” or “food kibble” refers to a particulate pellet like component of animal feeds, such as dog and cat feeds. In some embodiments, a food kibble has a moisture, or water, content of less than 15% by weight. Food kibbles may range in texture from hard to soft. Food kibbles may range in internal structure from expanded to dense. Food kibbles may be formed by an extrusion process or a baking process. In non-limiting examples, a food kibble may have a uniform internal structure or a varied internal structure. For example, a food kibble may include a core and a coating to form a coated kibble. It should be understood that when the term “kibble” or “food kibble” is used, it can refer to an uncoated kibble or a coated kibble.

As used herein, the term “extrude” or “extrusion” refers to the process of sending preconditioned and/or prepared ingredient mixtures through an extruder. In some embodiments of extrusion, food kibbles are formed by an extrusion processes wherein a kibble dough, including a mixture of wet and dry ingredients, can be extruded under heat and pressure to form the food kibble. Any type of extruder can be used, examples of which include but are not limited to single screw extruders and twin-screw extruders. The list of sources, ingredients, and components as described hereinafter are listed such that combinations and mixtures thereof are also contemplated and within the scope herein.

The current invention relates to a food composition comprising quinoa grain in an amount effective to increase one or more parameters of commensals in an animal when the animal consumes the food composition, wherein the one or more parameters are selected from the group consisting of the percentage of Lactobacillus in total microbiota, the percentage of bifidobacteria in total microbiota, the percentage of Clostridium in total microbiota, and firmicutes to bacteroidetes ratio.

In addition, the current invention also relates to a method of altering one or more parameters of commensals in an animal, comprising feeding the animal a diet comprising quinoa grain in an amount effective to increase at least one of the percentage of Lactobacillus in total microbiota, the percentage of bifidobacteria in total microbiota, the percentage of Clostridium in total microbiota, or the firmicutes to bacteroidetes ratio in the animal.

In some embodiments, the animal is a pet. In specific embodiments, the animal is a cat, such as but not limited to a domesticated cat. In other specific embodiments, the animal is a dog, such as but not limited to a domesticated dog.

In some embodiments, the phrase “increasing one or more parameters of commensals” is used to refer, for example, to an increase of the levels of the one or more parameters in an animal over time during which the animal consumes the food composition containing effective amount of quinoa grain of the present invention compared to the levels of the one or more parameters in the same animal before the consumption of the food composition containing the effective amount of quinoa grain. Alternatively, in some embodiments, the phrase “increasing one or more parameters of commensals” is used to refer, for example, to an increase of the levels of the one or more parameters in an animal after a period of time during which the animal consumes the food composition containing effective amount of quinoa grain of the present invention compared to the levels of the one or more parameters in a control animal that consumes a control food composition in the same period. In one embodiment, the control food composition does not contain quinoa grain.

The method may further comprise measuring the levels of the one or more parameters in the animal prior to feeding the animal the diet comprising effective amount of quinoa grain. In some embodiments, baseline levels of the one or more parameters in the animal are established. In one embodiment, the baseline levels are a collection of single measurements of each of the one or more parameters prior to feeding the animal the diet comprising effective amount of quinoa grain. In one embodiment, the baseline levels are averages of a number of measurements for the levels of each of the one or more parameters prior to feeding the animal the diet comprising effective amount of quinoa grain.

The method may further comprise measuring the levels of the one or more parameters in the same animal after the animal consumes the diet comprising effective amount of quinoa grain at different time points. Moreover, the method may further comprise comparing the baseline levels of the one or more parameters in the animal prior to feeding the animal the diet comprising effective amount of quinoa grain to the levels of the one or more parameters in the same animal after the animal consumes the diet comprising effective amount of quinoa grain for a period of time. According to the present invention, the quinoa grain in the diet is effective to increase the levels of the one or more parameters, such as but not limited to the percentage of Lactobacillus in total microbiota, the percentage of bifidobacteria in total microbiota, the percentage of Clostridium in total microbiota, and the firmicutes to bacteroidetes ratio.

In some embodiments of the present invention, the amount of the quinoa grain in the diet is effective to increase the percentage of Lactobacillus in total microbiota. In some embodiments, the amount of the quinoa grain in the diet is effective to increase the percentage of bifidobacteria in total microbiota. In some embodiments, the amount of the quinoa grain in the diet is effective to increase the percentage of Clostridium in total microbiota. In some embodiments, the amount of the quinoa grain in the diet is effective to increase the firmicutes to bacteroidetes ratio.

In some embodiments, the amount of the quinoa grain in the diet is effective to increase the percentage of Lactobacillus in total microbiota and the percentage of bifidobacteria in total microbiota. In some embodiments, the amount of the quinoa grain in the diet is effective to increase the percentage of Lactobacillus in total microbiota and the percentage of Clostridium in total microbiota. In some embodiments, the amount of the quinoa grain in the diet is effective to increase the percentage of Lactobacillus in total microbiota and the firmicutes to bacteroidetes ratio. In some embodiments, the amount of the quinoa grain in the diet is effective to increase the percentage of bifidobacteria in total microbiota and the percentage of Clostridium in total microbiota. In some embodiments, the amount of the quinoa grain in the diet is effective to increase the percentage of bifidobacteria in total microbiota and the firmicutes to bacteroidetes ratio. In some embodiments, the amount of the quinoa grain in the diet is effective to increase the percentage of Clostridium in total microbiota and the firmicutes to bacteroidetes ratio. In some specific embodiments, the amount of the quinoa grain in the diet is effective to increase the percentage of Lactobacillus in total microbiota and the percentage of Clostridium in total microbiota in a cat. In some specific embodiments, the amount of the quinoa grain in the diet is effective to increase the percentage of Lactobacillus in total microbiota and the percentage of Clostridium in total microbiota in a cat, but not the percentage of bifidobacteria in total microbiota.

In some embodiments of the present invention, the amount of the quinoa grain in the diet is effective to increase the percentage of Lactobacillus in total microbiota, the percentage of bifidobacteria in total microbiota, and the percentage of Clostridium in total microbiota. In some embodiments, the amount of the quinoa grain in the diet is effective to increase the percentage of Lactobacillus in total microbiota and the percentage of bifidobacteria in total microbiota, and the firmicutes to bacteroidetes ratio. In some embodiments, the amount of the quinoa grain in the diet is effective to increase the percentage of bifidobacteria in total microbiota, the percentage of Clostridium in total microbiota, and the firmicutes to bacteroidetes ratio. In some specific embodiments, the amount of the quinoa grain in the diet is effective to increase the percentage of Lactobacillus in total microbiota, the percentage of bifidobacteria in total microbiota, and the firmicutes to bacteroidetes ratio in a dog. In some specific embodiments, the amount of the quinoa grain in the diet is effective to increase the percentage of Lactobacillus in total microbiota, the percentage of bifidobacteria in total microbiota, and the firmicutes to bacteroidetes ratio, but not the percentage of Clostridium in total microbiota in a dog.

In some embodiments of the present invention, the amount of the quinoa grain in the diet is effective to increase the percentage of Lactobacillus in total microbiota, the percentage of bifidobacteria in total microbiota, the percentage of Clostridium in total microbiota, and the firmicutes to bacteroidetes ratio.

In some embodiments, a specific parameter for commensals may be measured with a method employing a series of nucleotide extractions, amplifications and sequencings, such as but not limited to the methods described for Examples 1 and 2, or any modifications thereof. For example, the percentage of a particular microbe may be calculated with the number of sequence reads associated with the microbe divided by the number of sequence reads associated with the total microbiota for a given sample/animal. The term “sequence reads” is understood in the art and refers to the frequency of occurrence of one or more gene sequences that belong to a particular species in a given sample. See Hand D. et al., PLoS ONE, 8(1): e53115, 2013 and Middelbos S. et al., PLoS ONE, 5(3): e9768, 2010, both of which are incorporated by reference. In particular, the percentage of Lactobacillus in total microbiota may be measured with the number of sequence reads associated with Lactobacillus divided by the number of sequence reads associated with the total microbiota for a given sample/animal. The percentage of bifidobacteria in total microbiota may be measured with the number of sequence reads associated with bifidobacteria divided by the number of sequence reads associated with the total microbiota for a given sample/animal. The percentage of Clostridium in total microbiota may be measured with the number of sequence reads associated with Clostridium divided by the number of sequence reads associated with the total microbiota for a given sample/animal. The firmicutes to bacteroidetes ratio may be measured with the number of sequence reads associated with the firmicutes divided by the number of sequence reads associated with the bacteroidetes for a given sample/animal.

In some embodiments, the methods of the present invention may be used to treat conditions or diseases in an animal that are treatable with commensals, the methods comprising feeding the animal a diet comprising quinoa grain in an effective amount to increase one or more parameters of commensals, wherein the one or more parameters are selected from the group consisting of the percentage of Lactobacillus in total microbiota, the percentage of bifidobacteria in total microbiota, the percentage of Clostridium in total microbiota, and firmicutes to bacteroidetes ratio. Such conditions or diseases may include but not be limited to diarrhea, dental infections, nasal colonization, Clostridium difficile colitis, Helicobacter pylori infection, inflammatory bowel disease, irritable bowel syndrome, intestinal inflammation, rheumatoid arthritis, cancer such as but not limited to gastric related cancer, and graft-versus-host disease.

In some embodiments, the methods of the present invention may be used to reduce the likelihood of developing conditions or diseases in an animal that are treatable with commensals, the method comprising feeding the animal a diet comprising quinoa grain in an effective amount to increase one or more parameters of commensals, wherein the one or more parameters are selected from the group consisting of the percentage of Lactobacillus in total microbiota, the percentage of bifidobacteria in total microbiota, the percentage of Clostridium in total microbiota, and firmicutes to bacteroidetes ratio. Such conditions or diseases may include but not be limited to diarrhea, dental infections, nasal colonization, Clostridium difficile colitis, Helicobacter pylori infection, inflammatory bowel disease, irritable bowel syndrome, intestinal inflammation, rheumatoid arthritis, cancer and graft-versus-host disease.

The quinoa grain in the diet may be in an amount effective to increase the percentage of Lactobacillus in total microbiota, the percentage of bifidobacteria in total microbiota, the percentage of Clostridium in total microbiota, or the firmicutes to bacteroidetes ratio in an animal after the animal consumes the diet for a period of time compared to baseline levels in the same animal. For example, the amount of quinoa grain in the diet may be effective to increase the percentage of Lactobacillus in total microbiota, the percentage of bifidobacteria in total microbiota, the percentage of Clostridium in total microbiota, or the firmicutes to bacteroidetes ratio in an animal after the animal consumes the diet comprising effective amount of quinoa grain for about or at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 101, 105, 110, 113, 115, 120, 125, 130, 135, 140, 145 or 150 days compared to baseline levels in the same animal. In some embodiments, the amount of quinoa grain in the diet may be effective to increase the percentage of Lactobacillus in total microbiota, the percentage of bifidobacteria in total microbiota, the percentage of Clostridium in total microbiota, or the firmicutes to bacteroidetes ratio in an animal after the animal consumes the diet comprising effective amount of quinoa grain for within about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 101, 105, 110, 113, 115, 120, 125, 130, 135, 140, 145 or 150 days compared to baseline levels in the same animal.

The quinoa grain in the diet may be in an amount effective to increase the percentage of Lactobacillus in total microbiota, the percentage of bifidobacteria in total microbiota, the percentage of Clostridium in total microbiota, or the firmicutes to bacteroidetes ratio in an animal after the animal consumes the diet for a period of time compared to levels of the same parameters in a control animal consuming control food compositions in the same period. For example, the amount of quinoa grain in the diet may be effective to increase the percentage of Lactobacillus in total microbiota, the percentage of bifidobacteria in total microbiota, the percentage of Clostridium in total microbiota, or the firmicutes to bacteroidetes ratio in an animal after the animal consumes the diet comprising effective amount of quinoa grain for about or at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 101, 105, 110, 113, 115, 120, 125, 130, 135, 140, 145 or 150 days compared to levels of the same parameters in a control animal consuming control food compositions in the same period. In some embodiments, the amount of quinoa grain in the diet may be effective to increase the percentage of Lactobacillus in total microbiota, the percentage of bifidobacteria in total microbiota, the percentage of Clostridium in total microbiota, or the firmicutes to bacteroidetes ratio in an animal after the animal consumes the diet comprising effective amount of quinoa grain for within about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 101, 105, 110, 113, 115, 120, 125, 130, 135, 140, 145 or 150 days compared to levels of the same parameters in a control animal consuming control food compositions in the same period.

In some embodiments, the quinoa grain in the diet is in an amount effective to increase the percentage of Lactobacillus in total microbiota in the animal consuming the diet compared to baseline percentage of Lactobacillus in total microbiota in the same animal or compared to the percentage of Lactobacillus in total microbiota in a control animal consuming a control diet. For example, after consuming the diet comprising effective amount of quinoa grain for a period of time, the percentage of Lactobacillus in total microbiota in the animal may be increased by about or at least about 5%, 10%, 15%, 20%, 25%, 30%, 35%, 40%, 45%, 50%, 55%, 60%, 65%, 70%, 75%, 80%, 85%, 90%, 100%, 105%, 110%, 115%, 120%, 125%, 130%, 135%, 140%, 145%, 150%, 155%, 160%, 165%, 170%, 175%, 180%, 185%, 190%, 195%, 200%, 205%, 210%, 215%, 220%, 225%, 230%, 235%, 240%, 245%, or 250% compared to baseline percentage of Lactobacillus in total microbiota in the animal prior to consumption of the diet comprising effective amount of quinoa grain or compared to the percentage of Lactobacillus in total microbiota in a control animal consuming a control diet. In one embodiment, the amount of quinoa grain in the diet is effective to increase the percentage of Lactobacillus in total microbiota by about or at least about 35%. In one embodiment, the amount of quinoa grain in the diet is effective to increase the percentage of Lactobacillus in total microbiota by about or at least about 35% in a dog. In another embodiment, the amount of quinoa grain in the diet is effective to increase the percentage of Lactobacillus in total microbiota by about or at least about 200%. In another embodiment, the amount of quinoa grain in the diet is effective to increase the percentage of Lactobacillus in total microbiota by about or at least about 200% in a cat. For example, if the baseline percentage of Lactobacillus in total microbiota is 12.91% and the measured percentage of Lactobacillus in total microbiota is 17.44% after consumption of a diet comprising effective amount of quinoa grain, the increase would be (17.44−12.91)/12.91=35%.

In some embodiments, the quinoa grain in the diet is in an amount effective to increase the percentage of bifidobacteria in total microbiota in the animal consuming the diet compared to baseline percentage of bifidobacteria in total microbiota in the same animal or compared to the percentage of bifidobacteria in total microbiota in a control animal consuming a control diet. For example, after consuming the diet comprising effective amount of quinoa grain for a period of time, the percentage of bifidobacteria in total microbiota in the animal may be increased by about or at least about 5%, 10%, 15%, 20%, 25%, 30%, 35%, 40%, 45%, 50%, 55%, 60%, 65%, 70%, 75%, 80%, 85%, 90%, 100%, 105%, 110%, 115%, 120%, 125%, 130%, 135%, 140%, 145%, 150%, 155%, 160%, 165%, 170%, 175%, 180%, 185%, 190%, 195%, 200%, 205%, 210%, 215%, 220%, 225%, 230%, 235%, 240%, 245%, or 250% compared to baseline percentage of bifidobacteria in total microbiota in the animal prior to consumption of the diet comprising effective amount of quinoa grain or compared to the percentage of bifidobacteria in total microbiota in a control animal consuming a control diet. In one embodiment, the amount of quinoa grain in the diet is effective to increase the percentage of bifidobacteria in total microbiota by about or at least about 80%. In one embodiment, the amount of quinoa grain in the diet is effective to increase the percentage of bifidobacteria in total microbiota by about or at least about 80% in a dog. For example, if the baseline percentage of bifidobacteria in total microbiota is 1.15% and the measured percentage of bifidobacteria in total microbiota is 2.09% after consumption of a diet comprising effective amount of quinoa grain, the increase would be (2.09−1.15)/1.15=81.7%.

In some embodiments, the quinoa grain in the diet is in an amount effective to increase the percentage of Clostridium in total microbiota in the animal consuming the diet compared to baseline percentage of Clostridium in total microbiota in the same animal or compared to the percentage of Clostridium in total microbiota in a control animal consuming a control diet. For example, after consuming the diet comprising effective amount of quinoa grain for a period of time, the percentage of Clostridium in total microbiota in the animal may be increased by about or at least about 5%, 10%, 15%, 20%, 25%, 30%, 35%, 40%, 45%, 50%, 55%, 60%, 65%, 70%, 75%, 80%, 85%, 90%, 100%, 105%, 110%, 115%, 120%, 125%, 130%, 135%, 140%, 145%, 150%, 155%, 160%, 165%, 170%, 175%, 180%, 185%, 190%, 195%, 200%, 205%, 210%, 215%, 220%, 225%, 230%, 235%, 240%, 245%, or 250% compared to baseline percentage of Clostridium in total microbiota in the animal prior to consumption of the diet comprising effective amount of quinoa grain or compared to the percentage of Clostridium in total microbiota in a control animal consuming a control diet. In one embodiment, the amount of quinoa grain in the diet is effective to increase the percentage of Clostridium in total microbiota by about or at least about 175%. In one embodiment, the amount of quinoa grain in the diet is effective to increase the percentage of Clostridium in total microbiota by about or at least about 175% in a cat. For example, if the baseline percentage of Clostridium in total microbiota is 1.89% and the measured percentage of Clostridium in total microbiota is 5.22% after consumption of a diet comprising effective amount of quinoa grain, the increase would be 5.22−1.89)/1.89=176%.

In some embodiments, the quinoa grain in the diet is in an amount effective to increase the firmicutes to bacteroidetes ratio in the animal consuming the diet compared to baseline firmicutes to bacteroidetes ratio in the same animal or compared to the firmicutes to bacteroidetes ratio in a control animal consuming a control diet. For example, after consuming the diet comprising effective amount of quinoa grain for a period of time, the firmicutes to bacteroidetes ratio in the animal may be increased by about or at least about 5%, 10%, 15%, 20%, 25%, 30%, 35%, 40%, 45%, 50%, 55%, 60%, 65%, 70%, 75%, 80%, 85%, 90%, 100%, 105%, 110%, 115%, 120%, 125%, 130%, 135%, 140%, 145%, 150%, 155%, 160%, 165%, 170%, 175%, 180%, 185%, 190%, 195%, 200%, 205%, 210%, 215%, 220%, 225%, 230%, 235%, 240%, 245%, or 250% compared to baseline firmicutes to bacteroidetes ratio in the animal prior to consumption of the diet comprising effective amount of quinoa grain or compared to the firmicutes to bacteroidetes ratio in a control animal consuming a control diet. In one embodiment, the amount of quinoa grain in the diet is effective to increase the firmicutes to bacteroidetes ratio by about or at least about 110%. In one embodiment, the amount of quinoa grain in the diet is effective to increase the firmicutes to bacteroidetes ratio by about or at least about 110% in a dog. For example, if the baseline firmicutes to bacteroidetes ratio is 39.2 and the measured firmicutes to bacteroidetes ratio is 82.6 after consumption of a diet comprising effective amount of quinoa grain, the increase would be (82.6−39.2)/39.2=110.7%.

In one embodiment, the amount of quinoa grain in the diet is effective to increase the percentage of Lactobacillus in total microbiota by about at least about 35%, the percentage of bifidobacteria in total microbiota by about or at least about 80%, and the firmicutes to bacteroidetes ratio by about or at least about 110%. In one specific embodiment, the amount of quinoa grain in the diet is effective to increase the percentage of Lactobacillus in total microbiota by about at least about 35%, the percentage of bifidobacteria in total microbiota by about or at least about 80%, and the firmicutes to bacteroidetes ratio by about or at least about 110% in a dog consuming the diet compared to the baseline levels in the same dog. In another specific embodiment, the amount of quinoa grain in the diet is effective to increase the percentage of Lactobacillus in total microbiota by about at least about 35%, the percentage of bifidobacteria in total microbiota by about or at least about 80%, and the firmicutes to bacteroidetes ratio by about or at least about 110% in a dog consuming the diet compared to the percentage of Lactobacillus in total microbiota, the percentage of bifidobacteria in total microbiota, and the firmicutes to bacteroidetes ratio in a control dog consuming a control diet.

In one embodiment, the amount of quinoa grain in the diet is effective to increase the percentage of Lactobacillus in total microbiota by about at least about 200% and the percentage of Clostridium in total microbiota by about or at least about 175%. In one specific embodiment, the amount of quinoa grain in the diet is effective to increase the percentage of Lactobacillus in total microbiota by about at least about 200% and the percentage of Clostridium in total microbiota by about or at least about 175% in a cat compared to the baseline levels in the same cat. In another specific embodiment, the amount of quinoa grain in the diet is effective to increase the percentage of Lactobacillus in total microbiota by about at least about 200% and the percentage of Clostridium in total microbiota by about or at least about 175% in a cat compared to the percentage of Lactobacillus in total microbiota and the percentage of Clostridium in a control cat consuming a control diet.

The food composition of the present invention may comprise quinoa grain. In some embodiments, the quinoa grain may be about or less than about 0.001%, 0.01%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 20%, 25%, 30%, 35%, 40%, 45%, 50%, 55%, 60%, 65%, 70%, 75% or 80% of the total food composition by weight. In some embodiments, the quinoa grain may be more than about 0.001%, 0.01%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 20%, 25%, 30%, 35%, 40%, 45%, 50%, 55%, 60%, 65%, 70%, 75% or 80% of the total food composition by weight. In some embodiments, the quinoa grain may be about 1-30%, 2-30%, 3-30%, 4-30%, 5-30%, 1-25%, 2-25%, 3-25%, 4-25%, 5-25%, 1-20%, 2-30%, 3-20%, 4-20%, 5-20%, 5-19%, 5-18%, 5-17%, 5-16%, 5-15%, 5-14%, 5-13%, 5-12%, 5-11%, 5-10%, 10-20%, 10-19%, 10-18%, 10-17%, 10-16%, 10-15%, 10-14%, 10-13%, 10-12%, or 10-11% of the total food composition by weight.

The food composition containing effective amount of quinoa grain may be combined or mixed with food composition that does not contain quinoa grain. For example, the food composition containing effective amount of quinoa grain may be more than about 1%, 5%, 10%, 15%, 20%, 25%, 30%, 35%, 40%, 45%, 50%, 55%, 60%, 65%, 70%, 75%, 80%, 85%, 90%, 95% or 99% of the total food composition by weight. In some embodiments, the food composition containing effective amount of quinoa grain may be less than about 1%, 5%, 10%, 15%, 20%, 25%, 30%, 35%, 40%, 45%, 50%, 55%, 60%, 65%, 70%, 75%, 80%, 85%, 90%, 95%, 99% or 100% of the total food composition by weight. In some embodiments, the diet of the present invention may comprise the food composition comprising effective amount of quinoa grain and other food compositions that do not comprise quinoa grain.

The food composition containing effective amount of quinoa grain may comprise different kinds of food products. For example, the food composition containing effective amount of quinoa grain may comprise one or more types of dry food (e.g. pellets or kibbles), semi-moist food or wet food. The different kinds of food products may comprise different amount of quinoa grain and some of the food products may not comprise quinoa grain. For example, a food composition may comprise dry food comprising quinoa grain and semi-moist food that does not comprise quinoa grain and/or we food that does not comprise quinoa grain. In one embodiment, the dry food containing quinoa grain may be more than about 1%, 5%, 10%, 15%, 20%, 25%, 30%, 35%, 40%, 45%, 50%, 55%, 60%, 65%, 70%, 75%, 80%, 85%, 90%, 95% or 99% of the total food composition by weight. In another embodiment, the dry food containing quinoa grain may be less than about 5%, 10%, 15%, 20%, 25%, 30%, 35%, 40%, 45%, 50%, 55%, 60%, 65%, 70%, 75%, 80%, 85%, 90%, 95%, 99% or 100% of the total food composition by weight. In some embodiments, the dry food containing quinoa grain may be combined or mixed with semi-moist food or wet food that also contain quinoa grain, in the same or a different amount. In some embodiments, the dry food containing quinoa grain may be more than about 1%, 5%, 10%, 15%, 20%, 25%, 30%, 35%, 40%, 45%, 50%, 55%, 60%, 65%, 70%, 75%, 80%, 85%, 90%, 95% or 99% of the total food composition by weight. In some embodiments, the dry food containing quinoa grain may be less than about 5%, 10%, 15%, 20%, 25%, 30%, 35%, 40%, 45%, 50%, 55%, 60%, 65%, 70%, 75%, 80%, 85%, 90%, 95%, 99% or 100% of the total food composition by weight.

The current invention also relates to methods of making a pet food composition, wherein the food composition comprises quinoa grain in an amount effective to increase one or more parameters in an animal after the animal consumes the food composition, wherein the one or more parameters are selected from the group consisting of the percentage of Lactobacillus in total microbiota, the percentage of bifidobacteria in total microbiota, the percentage of Clostridium in total microbiota, and the firmicutes to bacteroidetes ratio.

In some embodiments, the current invention also relates to relates to methods for making a pet food composition comprising the steps of (a) preconditioning by mixing wet and dry ingredients at elevated temperature to form a dough; (b) extruding the dough at a high temperature and pressure to form an extruded kibble; (c) drying the extruded kibble; and (d) enrobing the dried kibble with topical liquid and/or dry ingredients, wherein quinoa grain is applied to the kibble at step (a) and/or (d), in an amount effective to increase one or more parameters of commensals in an animal when the animal consumes the food composition, wherein the one or more parameters are selected from the group consisting of the percentage of Lactobacillus in total microbiota, the percentage of bifidobacteria in total microbiota, the percentage of Clostridium in total microbiota, and firmicutes to bacteroidetes ratio.

In some embodiments, the quinoa grain is applied to the dough in step (a) by mixing with other ingredient to form the dough. In one embodiment, the quinoa grain is applied as a dry ingredient in step (a). In one embodiment, the quinoa grain is applied in the form of flour derived from quinoa seeds.

The dough can be prepared in any suitable means from any suitable ingredients, such as, for example, a protein source, a carbohydrate source, a fat source, and any other ingredients suitable for animal or pet nutrition.

Similarly, the topical liquid and/or dry ingredients that are used for enrobing the dough can be prepared in any suitable means from any suitable ingredients, such as, for example, a protein source, a carbohydrate source, a fat source, and any other ingredients suitable for animal or pet nutrition.

In some embodiments, the food composition of the present invention comprise one or more ingredients such as but not limited to flax, corn, rim brewers, pea, chicken, soybean, tomato, cellulose, wheat, beet, lysine, potassium chloride, methionine, sodium chloride, carrot, dicalcium phosphate, vitamin premix, carnitine, lipoic acid alpha, mineral premix, calcium carbonate, taurine, glucosamine hydrochloride, chondroitin sulfate, grain blend, lactic acid, choline chloride, grain blend, palatant, fish oil, coconut oil, vitamin E oil, starch, poultry, fish, dairy, pork, beef, lamb, venison, and rabbit.

In some embodiments, the food composition of the present invention comprise one or more amino acid such as but not limited to arginine, histidine, isoleucine, leucine, lysine, methionine, phenylala nine, threonine, tryptophan, valine, taurine, carnitine, alanine, aspartate, cystine, glutamate, glutamine, glycine, proline, serine, tyrosine, and hydroxyproline.

In some embodiments, the food composition of the present invention comprise one or more fatty acids such as but not limited to lauric acid, myristic acid, palmitic acid, palmitoleic acid, margaric acid, margaroleic acid, stearic acid, oleic acid, linoleic acid, g-linolenic acid, a-linolenic acid, stearidonic acid, arachidic acid, gadoleic acid, DHGLA, arachidonic acid, eicossatetra acid, EPA, behenic acid, erucic acid, docosatetra acid, and DPA.

In some embodiments, the food composition of the present invention comprise one or more macro nutrients such as but not limited to moisture, protein, fat, crude fiber, ash, dietary fiber, soluble fiber, insoluble fiber, raffinose, and stachyose.

In some embodiments, the food composition of the present invention comprise one or more micro nutrients such as but not limited to beta-carotene, alpha-lipoic acid, glucosamine, chondroitin sulfate, lycopene, lutein, and quercetin.

In some embodiments, the food composition of the present invention comprise one or more minerals such as but not limited to calcium, phosphorus, potassium, sodium, chloride, iron, copper, copper, manganese, zinc, iodine, selenium, selenium, cobalt, sulfur, fluorine, chromium, boron, and oxalate.

In some embodiments, the food composition of the present invention comprise one or more vitamins such as but not limited to vitamin A, vitamin D, vitamin E, quinoa grain, vitamin C, thiamine, riboflavin, niacin, pyridoxine, pantothenic acid, folic acid, vitamin B12, biotin, and choline

### EXAMPLES

Studies were conducted in dogs and cats to demonstrate the effects of grains, including quinoa grain, on certain parameters for commensals and certain metabolites. The dogs in the study were adult dogs with age ranging from 3 years and 3 months to 8 years and 4 months and had no known health issues. The dogs were fed with diets comprising quinoa grain or other types of grain for 45 minutes overnight for 14 days. The cats in the study were adult cats with age ranging from 3 years and 8 months to 12 years and 10 months and had no known health issues. The cats were fed with diets comprising quinoa grain or other types of grain for 20 hours each day for 14 days. The dogs and cats maintained the target weight, especially during the collection period. Complete fecal output for dogs and cats was collected on days 11 through 15 and measurements were conducted with the fecal sample as shown in Examples 1-4. The groups of animals fed with different diets are shown in Table 1.

TABLE 1

| Diet | Tested Grain % | Canine | Feline |
|---|---|---|---|
| Control | | 23 | 26 |
| | 5% | 6 | 5 |
| Quinoa | 10% | 6 | 6 |
| | 20% | 6 | 5 |
| Buckweat | 5% | 6 | 6 |
| | 10% | 6 | 6 |
| | 20% | 6 | 6 |
| Amaranth | 5% | 6 | 6 |
| | 10% | 6 | 6 |
| | 20% | 6 | 6 |
| Coarse Bulghur | 5% | 6 | 6 |
| | 10% | 6 | 6 |
| | 20% | 6 | 6 |
| Fine Bulghur | 5% | 6 | 6 |
| | 10% | 6 | 6 |
| | 20% | 6 | 6 |
| Barley | 5% | 6 | 6 |
| | 10% | 6 | 6 |
| | 20% | 6 | 6 |

In Table 1, control for dogs refers to the group of dogs fed with a control diet containing 9.5% red whole wheat, 9.5% cracked barley, 9.5% whole corn, 9.5% whole sorghum and 13% brewers rice; control for cats refers to the group of cats fed with a diet containing 22% red whole wheat and 11% brewers rice. The other groups of dogs and cats were fed with diets containing different types of grain, such as the quinoa grain, in addition to the carbohydrate sources in the controls. The grains identified in Table 1 for the non-control groups for both dogs and cat were added by evenly replacing the carbohydrate sources in the respective control diets. The quinoa grain in the study was white quinoa. Each non-control group contains three sub-groups with 5%, 10% or 20% of the grain identified in Table 1. Table 1 also shows the number of dogs or cats in each group and sub-group.

Table 1A demonstrates the food intake of the groups of dogs and cats in Table 1.

TABLE 1A

| | | Canine | | Feline |
|---|---|---|---|---|
| | Canine | Food Intake | Feline | Food Intake |
| | Food Intake | (Food/BW- | Food Intake | (Food/BW- |
| Grain | (Food/BW) | met) | (Food/BW) | met) |
| Control | 107.8 | 196.6 | 62.9 | 95.3 |
| amaranth | 102.0 | 189.3 | 60.0 | 93.4 |
| barley | 105.6 | 197.6 | 59.7 | 90.3 |
| buckwheat | 119.3 | 214.3 | 64.2 | 97.5 |
| coarse | 103.8 | 193.3 | 61.9 | 94.1 |
| bulghur | | | | |
| fine bulghur | 110.1 | 205.7 | 62.7 | 95.0 |
| quinoa | 95.7 | 177.4 | 61.1 | 92.5 |

In Table 1A, the results are provided as average food intake (grams) divided by initial animal body weight (BW, kilograms). “Food/BW-met” refers to grams intake per kilogram body weight raised to the ¾ power, which is metabolic body weight and may more appropriately scales intake to weight. There was no statistically significant effect of grain on any of these parameters.

### Example 1

The results in Example 1 show that that quinoa grain can increase certain parameters for commensals. Dogs were fed a control diet or one of the six diets containing different types of grains as described in Table 1. Fecal samples were collected and analyzed for the percentage of Lactobacillus in total microbiota, the percentage of bifidobacteria in total microbiota, the percentage of Clostridium in total microbiota, and the firmicutes to bacteroidetes ratio.

Total fecal DNA was extracted from frozen feces samples by using a MOBIO POWERFECAL DNA Kit. Following total DNA extraction, 16s rRNA amplicon was developed from the samples by employing PCR using the primer sets spanning V3 and V5 (Canines) hypervariable regions and the amplicons were then qualitatively analyzed by an AGILENT 2100 Bioanalyzer. After the amplicon quality was verified, index PCR was performed followed by library quantification, normalization and pooling the samples. Final pooled sample library was loaded in a MISEQ v2 (for canines) sample loading cartridge kit and the cartridge was placed in a MISEQ ILLUMINA Sequencer for sequencing the samples. The library sequence files were further processed in MISEQ ILLUMINA Reporter to classify the sequence reads by using the Greengenes database. After developing the classification file, the abundance (expressed in percentage or ratio) of particular microbe at genera or phyla level was calculated with the number of sequence reads associated with a given genera or phyla divided by the number of sequence reads associated with the total microbiota for a given sample/animal.

In Tables 2-5, the results presented reflect an average of the measurements derived from subjects fed with the different diets with different grains. In Tables 2-5, LSMEAN refers to least squares means; Pr refers to probability.

The results for the percentage of Lactobacillus in total microbiota are shown in Table 2.

TABLE 2

| | Lactobacillus | | | |
|---|---|---|---|---|
| | LSMEAN | | | Pr |
| | (% in total | Standard | | (compared |
| Grain | microbiota) | Error | Pr > \| t \| | to control) |
| control | 12.9134516 | 2.4489897 | <.0001 | / |
| amaranth | 15.6739775 | 2.7074600 | <.0001 | 0.4510 |
| barley | 13.4523488 | 2.7074600 | <.0001 | 0.8829 |
| buckwheat | 14.8276195 | 2.7074600 | <.0001 | 0.6010 |
| coarse | 13.8214086 | 2.7074600 | <.0001 | 0.8040 |
| bulghur | | | | |
| fine | 11.8060322 | 2.7074600 | <.0001 | 0.7621 |
| bulghur | | | | |
| quinoa | 17.4353905 | 2.7074600 | <.0001 | 0.2178 |

The presence of quinoa in the diet resulted in a 35% increase of the percentage of Lactobacillus in total microbiota.

The results for the percentage of bifidobacteria in total microbiota are shown in Table 3.

TABLE 3

| | Bifidobacterium | | | |
|---|---|---|---|---|
| | LSMEAN | | | Pr |
| | (% total | Standard | | (compared |
| Grain | microbiota) | Error | Pr > \| t \| | to control) |
| control | 1.15075797 | 0.24747850 | <.0001 | / |
| amaranth | 1.04355372 | 0.27359777 | 0.0002 | 0.7719 |
| barley | 0.99880163 | 0.27359777 | 0.0004 | 0.6811 |
| buckwheat | 1.42966926 | 0.27359777 | <.0001 | 0.4511 |
| coarse | 1.14217285 | 0.27359777 | <.0001 | 0.9815 |
| bulghur | | | | |
| fine | 1.24373322 | 0.27359777 | <.0001 | 0.8014 |
| bulghur | | | | |
| quinoa | 2.09439977 | 0.27359777 | <.0001 | 0.0117 |

The presence of quinoa in the diet resulted in an 80% increase of the percentage of bifidobacteria in microbiota as compared to the control. Quinoa was also different from the other tested variables: amaranth (0.0076), barley (0.0054), buckwheat (0.0883), coarse bulghur (0.0152), and fine bulghur (0.0298) while no other grain differed from each other.

The results for the percentage of Clostridium in total microbiota are shown in Table 4.

TABLE 4

| | Clostridium | | | |
|---|---|---|---|---|
| | LSMEAN | | | Pr |
| | (% total | Standard | | (compared |
| Grain | microbiota) | Error | Pr > \| t \| | to control) |
| Control | 6.73710459 | 0.73165600 | <.0001 | / |
| amaranth | 6.10022228 | 0.80887614 | <.0001 | 0.5603 |
| barley | 6.38251222 | 0.80887614 | <.0001 | 0.7457 |
| buckwheat | 5.46534633 | 0.80887614 | <.0001 | 0.2459 |
| coarse | 8.56655828 | 0.80887614 | <.0001 | 0.0960 |
| bulghur | | | | |
| fine | 6.44645344 | 0.80887614 | <.0001 | 0.7903 |
| bulghur | | | | |
| quinoa | 7.23721711 | 0.80887614 | <.0001 | 0.6474 |

The results for the firmicutes to bacteroidetes ratio are shown in Table 5.

TABLE 5

| | firmicutes to | |
|---|---|---|
| | bacteroidetes ratio, | |
| Grain | LSMEAN | Static Error |
| control | 39.1938 | 15.4 |
| barley | 22.9734 | 19.5 |
| buckwheat | 81.6856 | 19.5 |
| coarse bulghur | 54.3820 | 19.5 |
| fine bulghur | 61.2558 | 19.5 |
| quinoa | 82.5855 | 19.5 |

The presence of quinoa in the diet resulted in a 110% increase of the firmicutes to bacteroidetes ratio.

### Example 2

Studies were conducted in cats to show that quinoa grain can increase certain parameters for commensals. Cats were fed a control diet or one of the six diets containing different types of grains as described in Table 1. Fecal samples were collected and analyzed for the percentage of Lactobacillus in total microbiota, the percentage of bifidobacteria in total microbiota, and the percentage of Clostridium in total microbiota.

Total fecal DNA was extracted from frozen feces samples by using a MOBIO POWERFECAL DNA Kit. Following total DNA extraction, 16s rRNA amplicon was developed from the samples by employing PCR using the primer sets spanning V3 and V4 (Felines) hypervariable regions and the amplicons were then qualitatively analyzed by an AGILENT 2100 Bioanalyzer. After the amplicon quality was verified, index PCR was performed followed by library quantification, normalization and pooling the samples. Final pooled sample library was loaded in a MISEQ v3 (for felines) sample loading cartridge kit and the cartridge was placed in a MISEQ ILLUMINA Sequencer for sequencing the samples. The sample sequence files were processed by using MOTHUR followed by standard methods and classify the sequence reads by using Greengenes database. After developing the classification file, the abundance (expressed in percentage) of particular microbe at genera or phyla level was calculated with the number of sequence reads associated with a given genera or phyla divided by the number of sequence reads associated with the total microbiota for a given sample/animal.

In Tables 6-8, the results presented reflect an average of the measurements derived from subjects fed with the different diets with different grains. In Tables 6-8, LSMEAN refers to least squares means; Pr refers to probability.

The results for the percentage of Lactobacillus in total microbiota are shown in Table 6.

TABLE 6

| | Lactobacillus | | | |
|---|---|---|---|---|
| | LSMEAN | | | Pr |
| | (% total | Standard | | (compared |
| Grain | microbiota) | Error | Pr > \| t \| | to control) |
| control | 3.9149677 | 1.6295018 | 0.0178 | / |
| amaranth | 3.6735114 | 1.9584174 | 0.0630 | 0.9246 |
| barley | 6.8341144 | 1.9584174 | 0.0007 | 0.2541 |
| buckwheat | 3.7656219 | 1.9584174 | 0.0568 | 0.9533 |
| coarse | 7.1343887 | 1.9584174 | 0.0004 | 0.2087 |
| bulghur | | | | |
| fine | 1.8801980 | 1.9584174 | 0.3389 | 0.4260 |
| bulghur | | | | |
| quinoa | 11.9740063 | 2.0772153 | <.0001 | 0.0028 |

The presence of quinoa in the diet resulted in a 206% increase of the percentage of Lactobacillus in total microbiota.

The results for the percentage of bifidobacteria in total microbiota are shown in Table 7.

TABLE 7

| | Bifidobacterium | | | |
|---|---|---|---|---|
| | LSMEAN | | | Pr |
| | (% total | Standard | | (compared |
| Grain | microbiota) | Error | Pr > \| t \| | to control) |
| Control | 18.3344624 | 2.0901409 | <.0001 | / |
| amaranth | 27.8488359 | 2.5120367 | <.0001 | 0.0043 |
| barley | 19.6638256 | 2.5120367 | <.0001 | 0.6849 |
| buckwheat | 22.6171439 | 2.5120367 | <.0001 | 0.1924 |
| coarse | 13.8721857 | 2.5120367 | <.0001 | 0.1745 |
| bulghur | | | | |
| fine | 15.4000629 | 2.5120367 | <.0001 | 0.3709 |
| bulghur | | | | |
| quinoa | 13.9269206 | 2.6644173 | <.0001 | 0.1955 |

The results for the percentage of Clostridium in total microbiota are shown in Table 8.

TABLE 8

| | Clostridium | | | |
|---|---|---|---|---|
| | LSMEAN | | | Pr |
| | (% total | Standard | | (compared |
| Grain | microbiota) | Error | Pr > \| t \| | to control) |
| control | 1.88852950 | 0.93372208 | 0.0452 | / |
| amaranth | 2.32641606 | 1.12219428 | 0.0402 | 0.7647 |
| barley | 4.02087906 | 1.12219428 | 0.0005 | 0.1466 |
| buckwheat | 1.88864683 | 1.12219428 | 0.0949 | 0.9999 |
| coarse | 2.87399750 | 1.12219428 | 0.0116 | 0.5009 |
| bulghur | | | | |
| fine | 5.33267183 | 1.12219428 | <.0001 | 0.0199 |
| bulghur | | | | |
| quinoa | 5.22100737 | 1.19026678 | <.0001 | 0.0294 |

The presence of quinoa in the diet resulted in a 176% increase of the percentage of Clostridium in total microbiota.

### Example 3

Dogs were fed a control diet or one of the six diets containing different types of grains at the concentrations of 5%, 10% or 20% as described in Table 1. Fecal samples were collected and analyzed for metabolites.

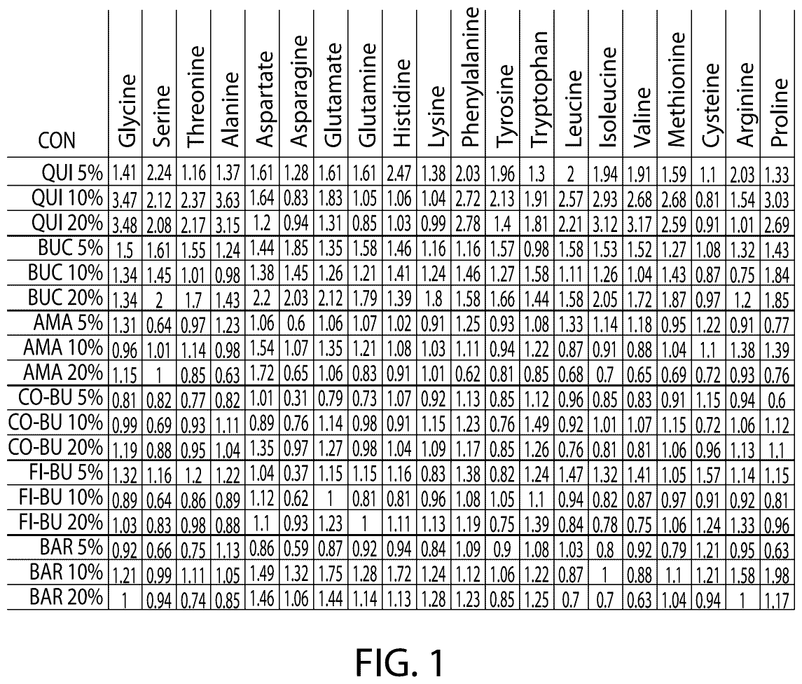

As shown in FIG. 1, fecal samples derived from dogs fed with either the quinoa or the buckwheat diet contained significantly higher levels of amino acids and their associated metabolites compared to the control and other dietary groups, suggesting that quinoa and buckwheat may contain higher amounts of protein and/or induce protein metabolism differently in canines.

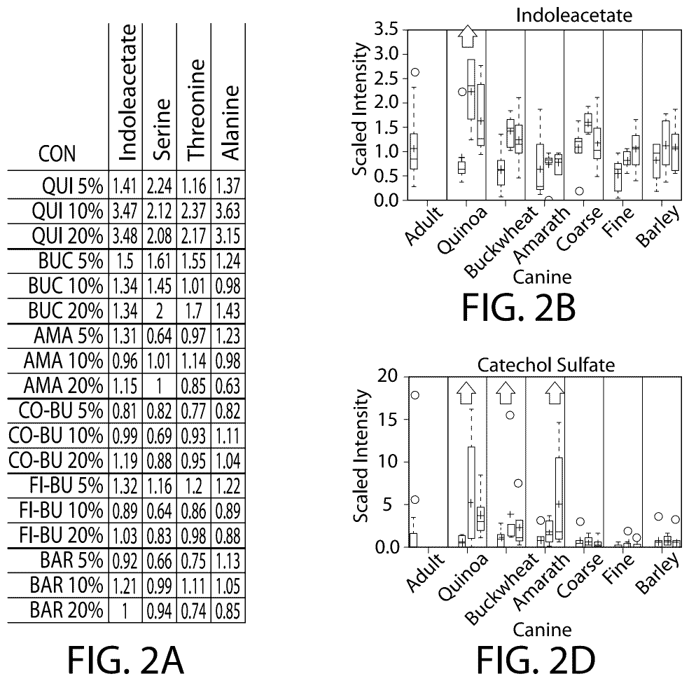

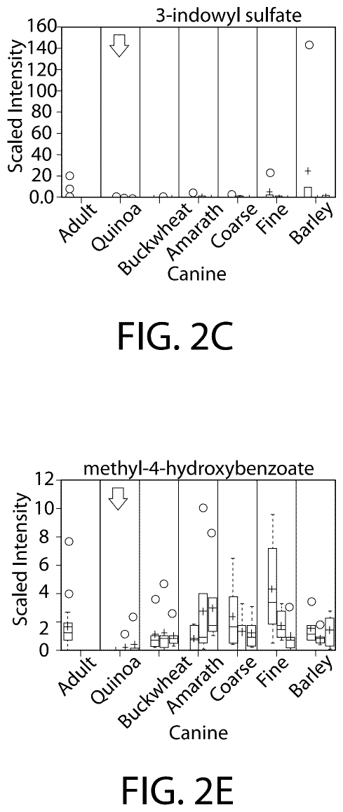

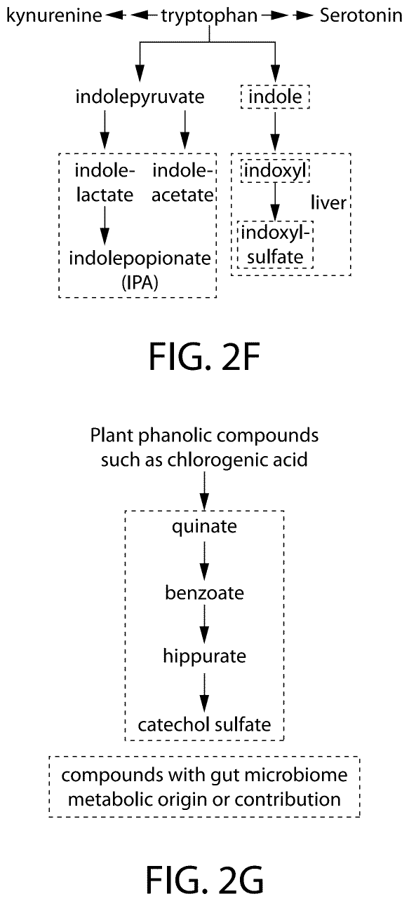

As shown in FIG. 2, dogs fed with the quinoa diet had significantly increased levels of indoleacetate and catechol sulfate, while decreased levels of 3-indoxyl sulfate and methyl-4-hydroxybenzoate compared to the controls. Buckwheat and amaranth appeared to increase the levels of catechol sulfate when given at high concentrations.

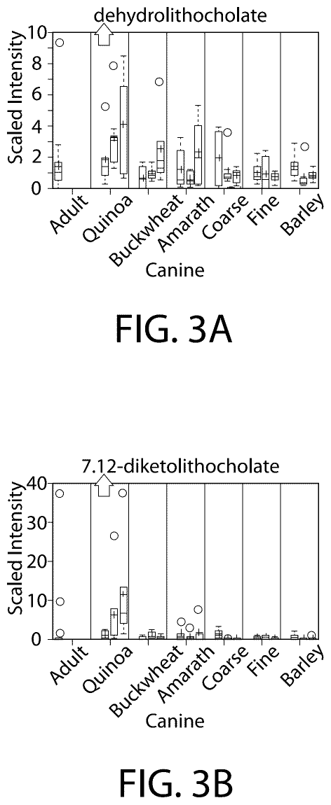

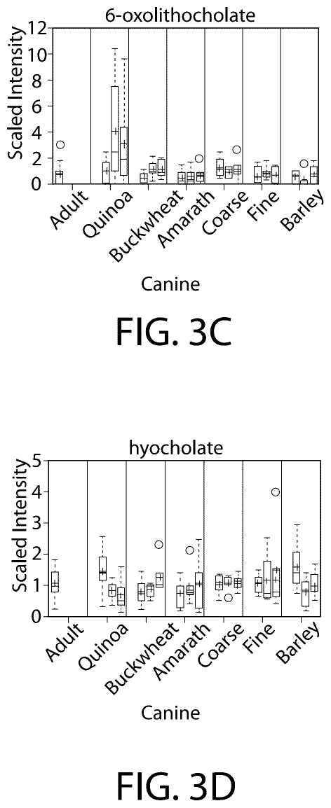

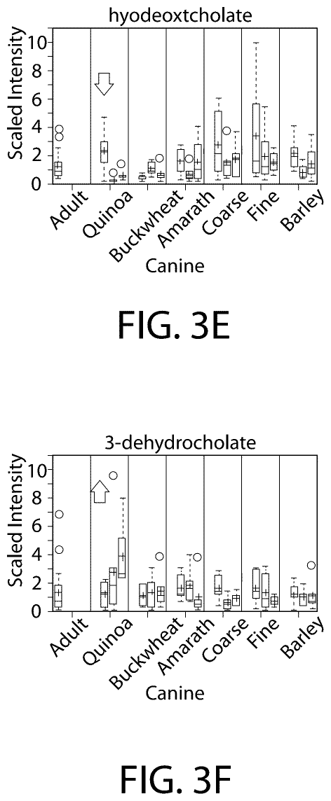

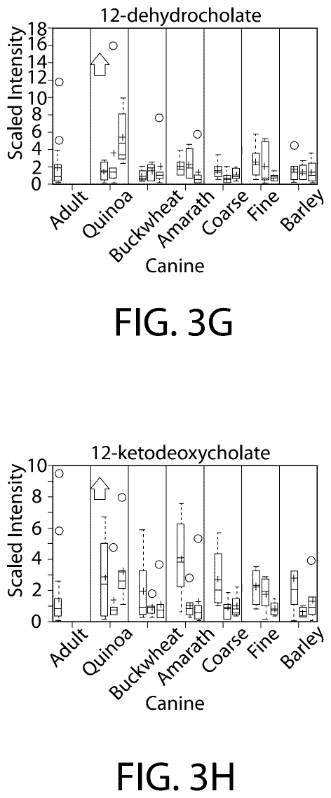

As shown in FIG. 3, dogs fed with the quinoa diet had significant changes in several secondary bile acids.

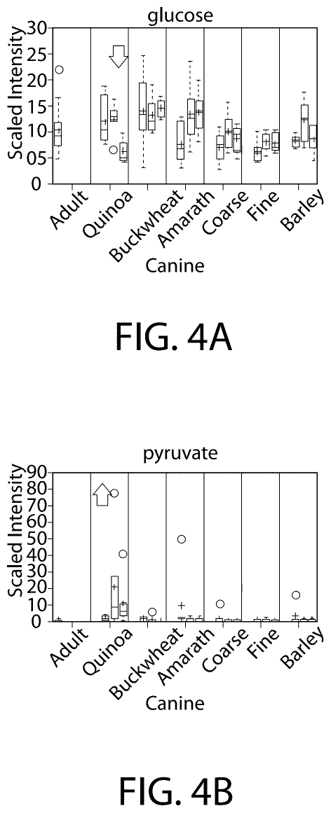

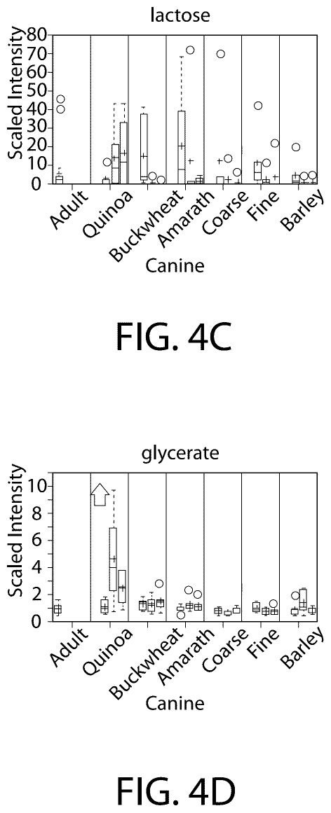

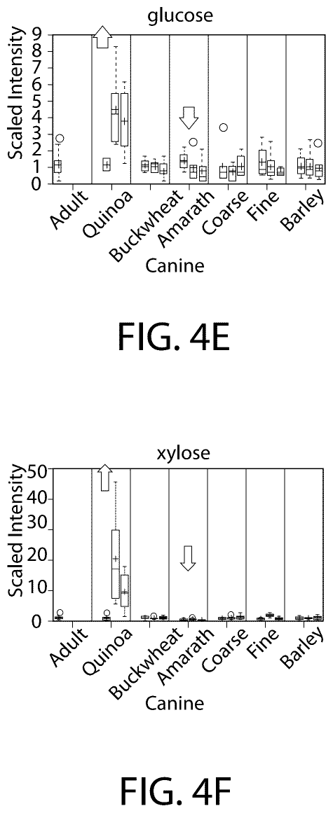

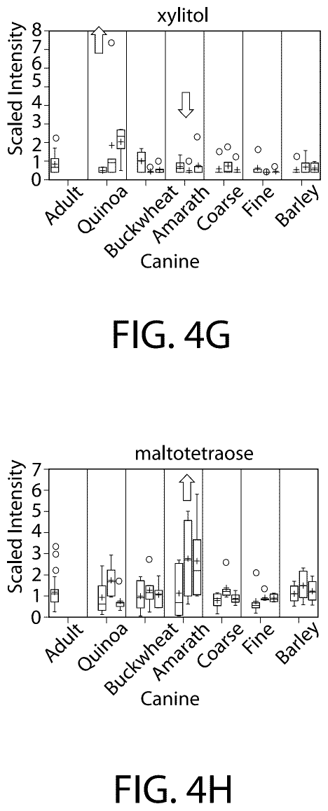

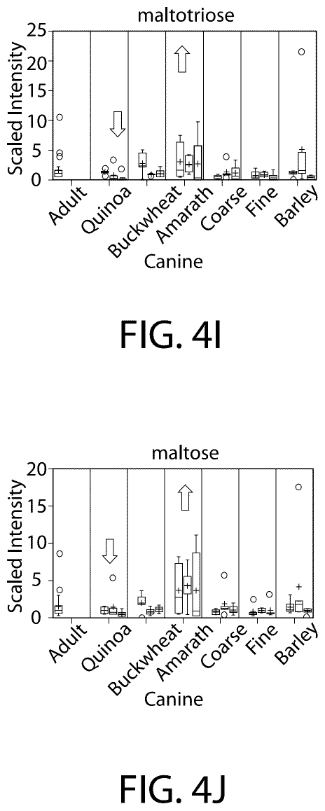

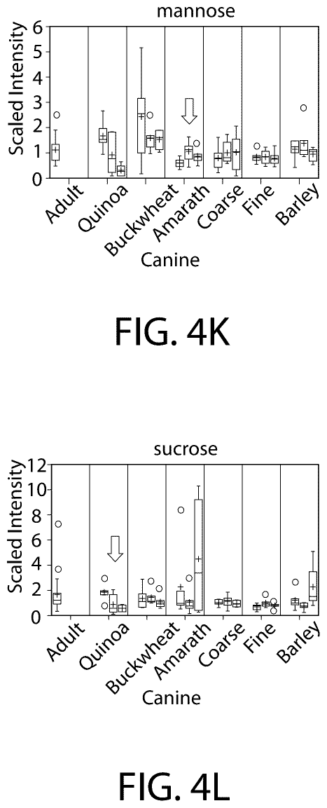

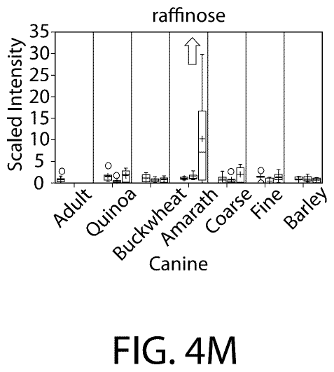

As shown in FIG. 4A and FIG. 4B, dogs fed with the quinoa diet had decreased levels of glucose, glycogen and sucrose, while increased levels of intermediates in the glycolytic and pentose phosphate pathways, suggesting an increased utilization of glucose for energy and nucleotide production. On the other hand, dogs fed with the amaranth diet had decreased levels of pentose intermediates and mannose, but increased levels of glycogen-related metabolites, such as maltotetraose, maltotriose and maltose, suggesting that amaranth favored glucose storage, perhaps reflecting the higher di- and oligo-saccharide contents in the amaranth diet.

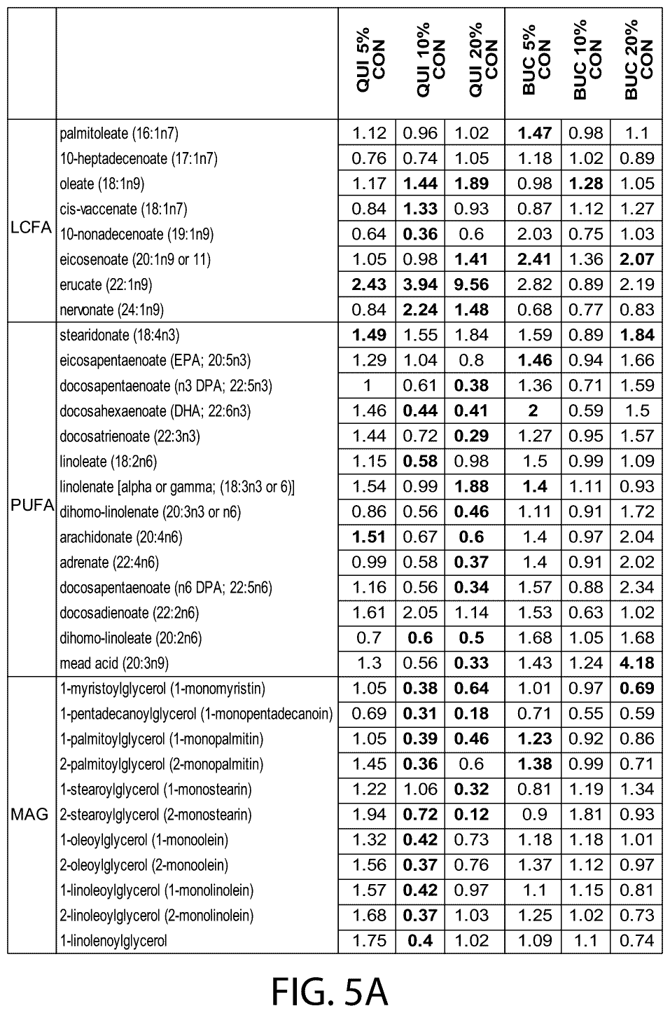

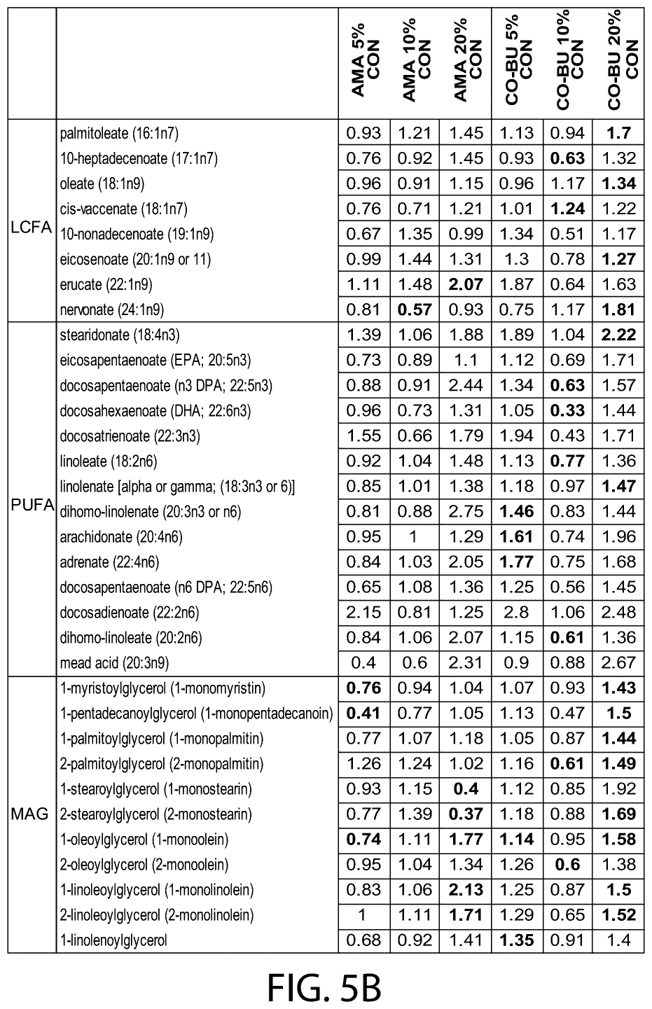

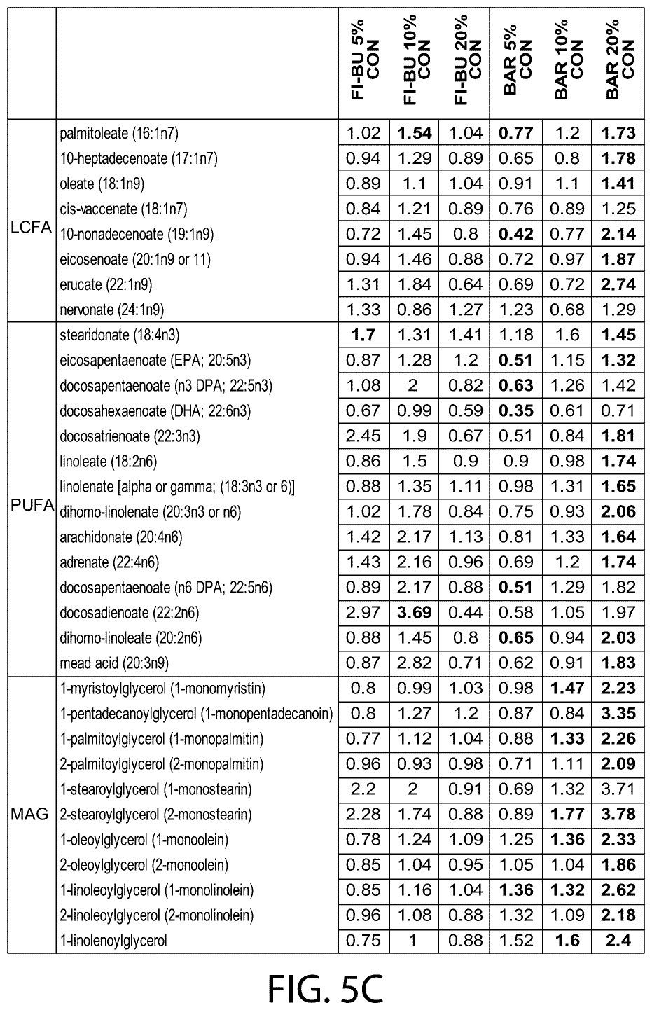

As shown in FIG. 5, dogs fed with the quinoa diet had increased levels of long chain fatty acids (LCFA), while decreased levels of polyunsaturated fatty acids (PUFA) and monoacylglycerols (MAG). On the other hand, dogs fed with the 20% Barley diet had increased levels of all these classes of lipid metabolites, indicating somewhat opposite effects.

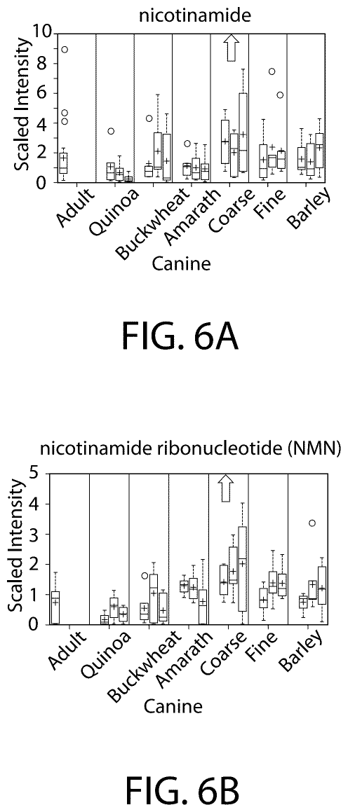

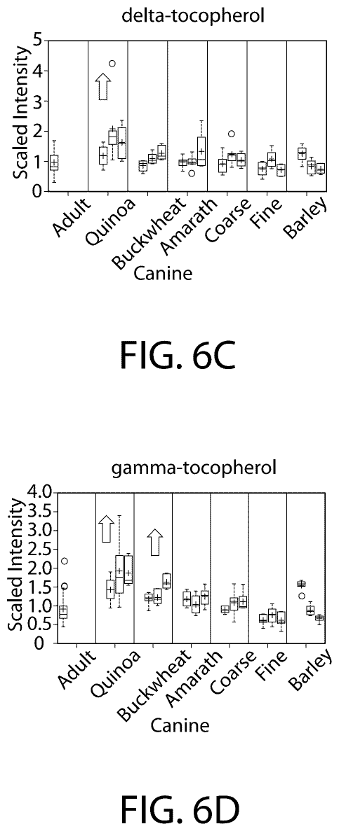

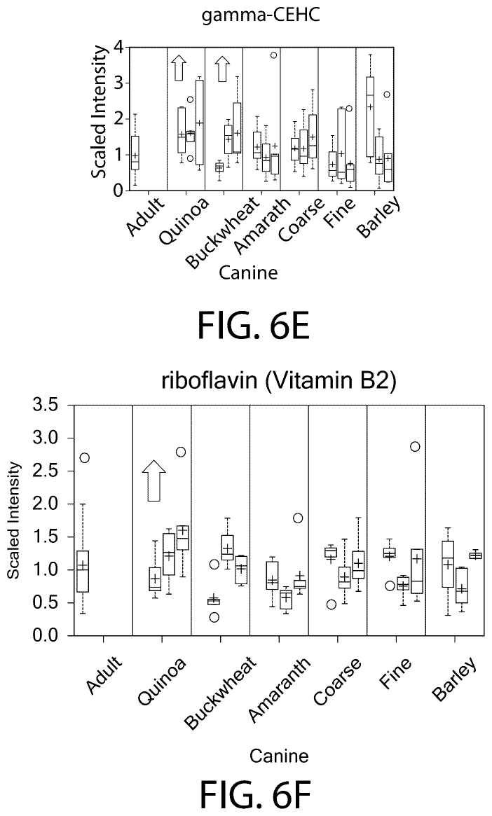

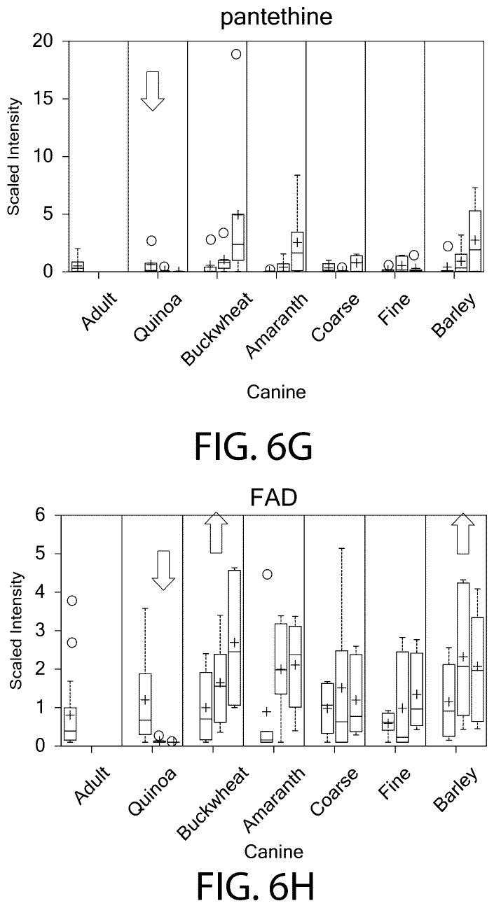

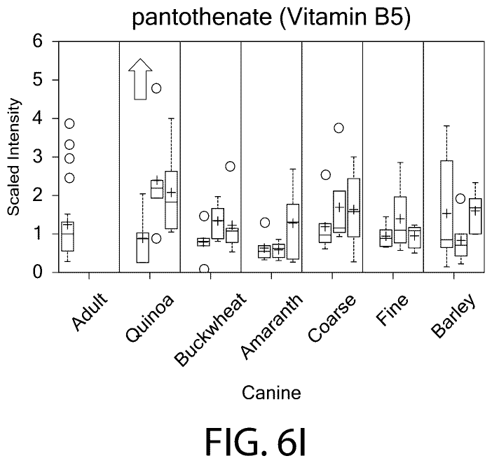

As shown in FIGS. 6A and 6B, dogs fed with the quinoa and buckwheat diets had relatively higher levels of tocopherols and tocopherol catabolites. Dogs fed with the coarse bulghur diet had increased nicotinamide and nicotinamide ribonucleotide compared to the controls and other dietary groups. Dogs fed with the Quinoa diet had increased levels of riboflavin (vitamin B2) but decreased levels of flavin adenine dinucleotide (FAD), indicating a reduced synthesis of FAD from riboflavin upon Quinoa ingestion. On the other hand, dogs fed buckwheat and barley had increased levels of FAD. Changes in FAD may greatly impact processes such as electron transport chain, fatty acid oxidation and folate synthesis, since all these processes require FAD as the cofactor.

FIGS. 6A and 6B also show that dogs fed with the quinoa diet had decreased pantethine but increased pantothenate. Pantethine is the precursor for pantothenate (vitamin B5), and both pantethine and pantothenate are involved in the biosynthesis pathway of Coenzyme A, suggesting that quinoa may impact the synthesis of Coenzyme A.

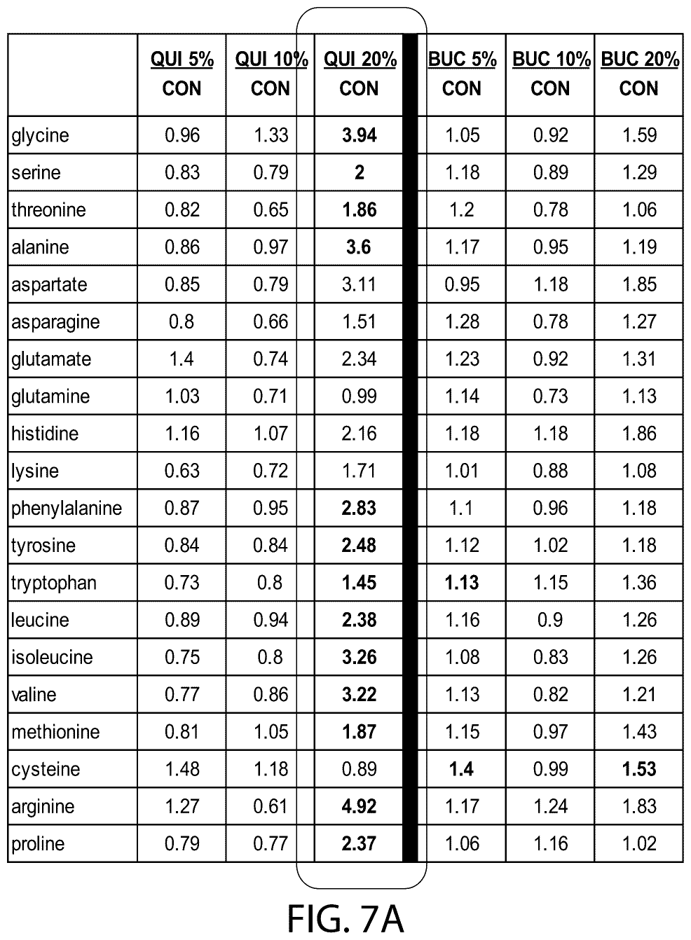

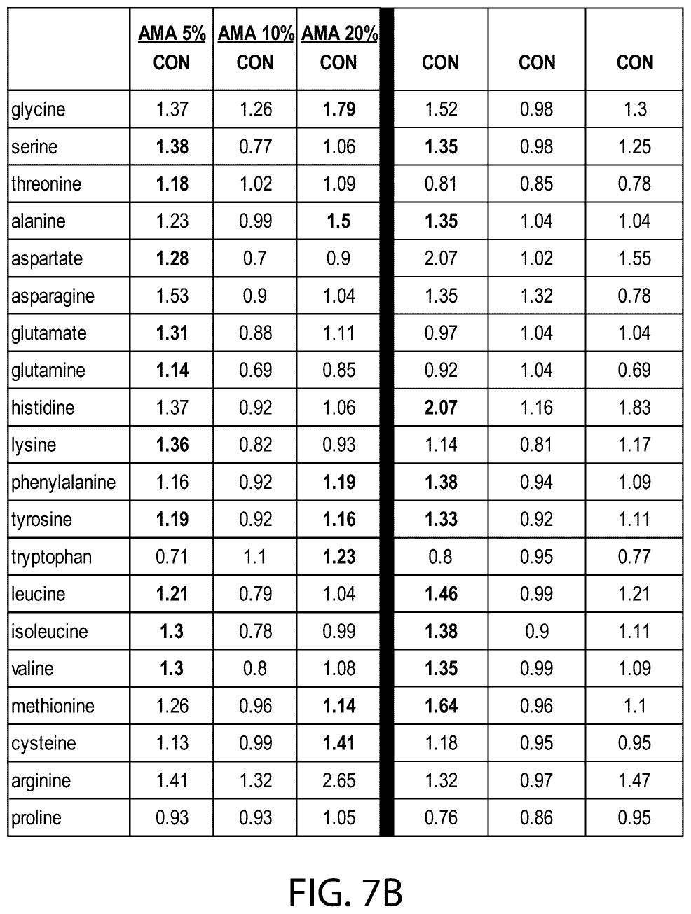

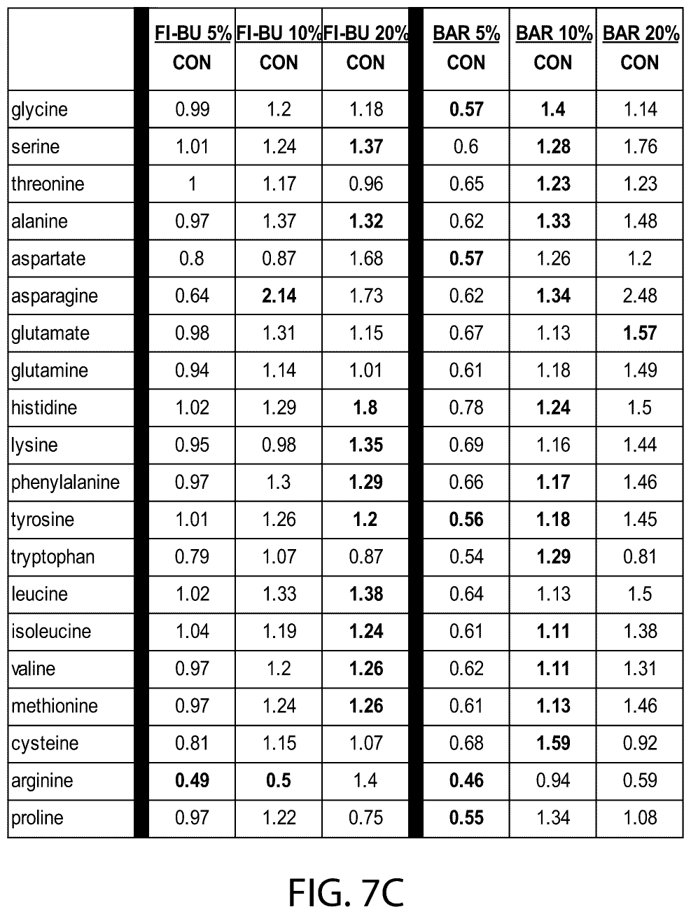

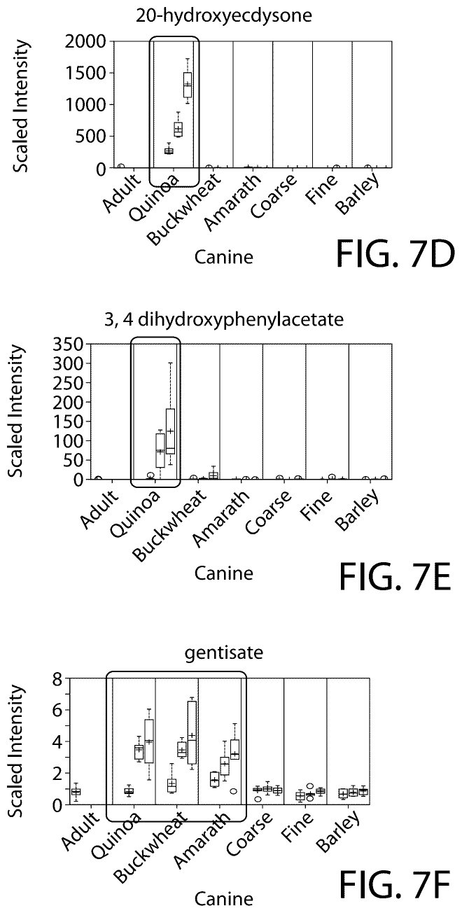

As shown in FIG. 7, dogs fed with the quinoa diet had increased amounts of 20-hydroxyecdysone (200-1800 fold increases relative to the control group), which may be involved in protein synthesis and muscle enhancement. FIG. 7 also show that quinoa, buckwheat and amaranth increased the levels of gentisate, a byproduct of tyrosine and benzoate metabolism and may have anti-inflammatory, antirheumatic and antioxidant properties. In addition, the quinoa increased the levels of 3,4-dihydroxyphenylacetate, a metabolite of dopamine that may be involved in antiproliferative effect in certain cancer lines.

### Example 4

Cats were fed a control diet or one of the six diets containing different types of grains at the concentrations of 5%, 10% or 20% as described in Table 1. Fecal samples were collected and analyzed for metabolites.

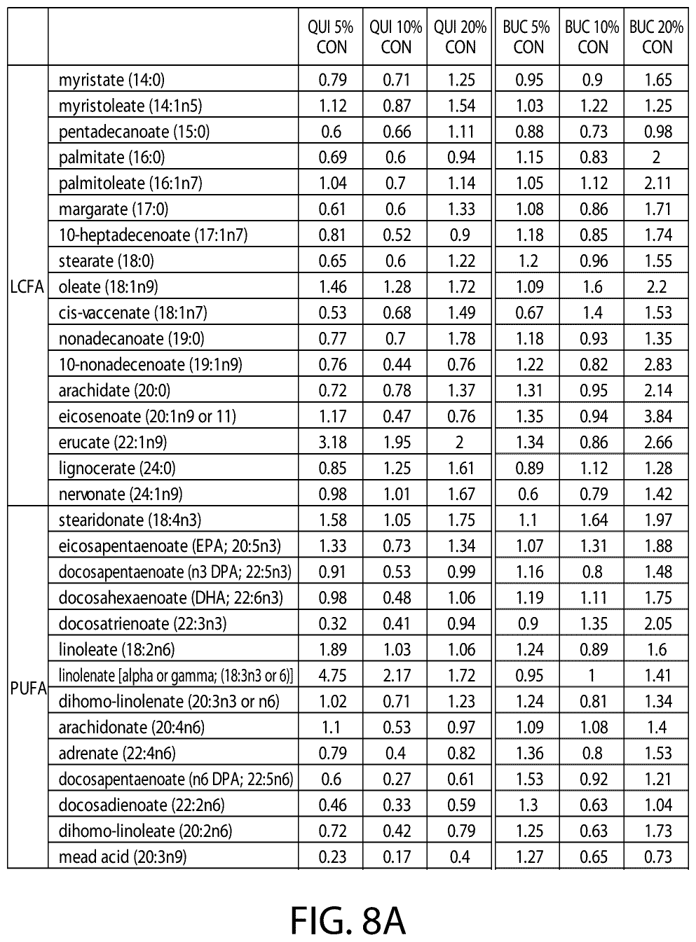

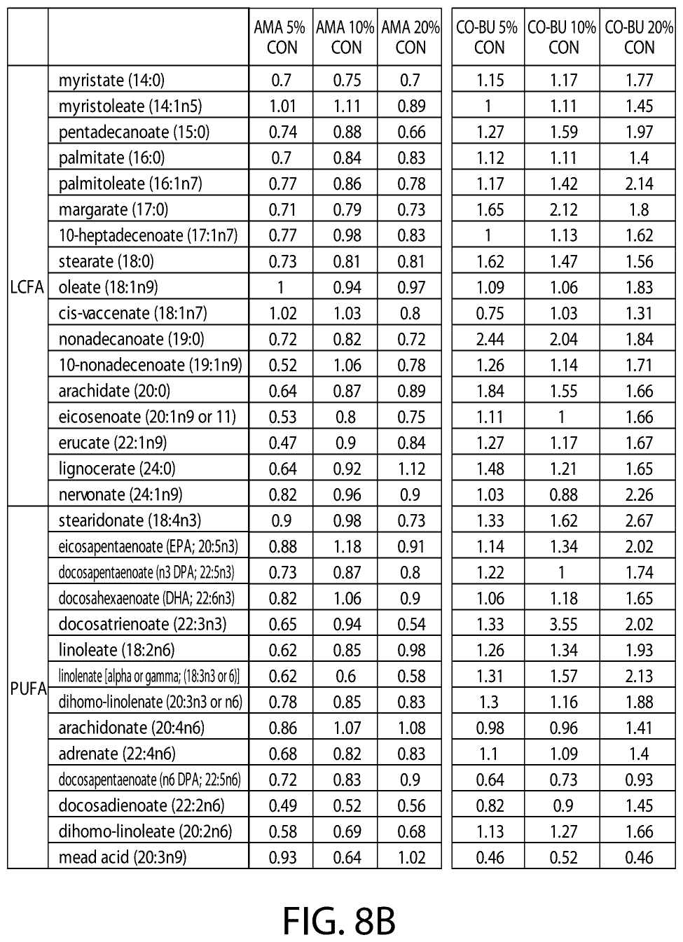

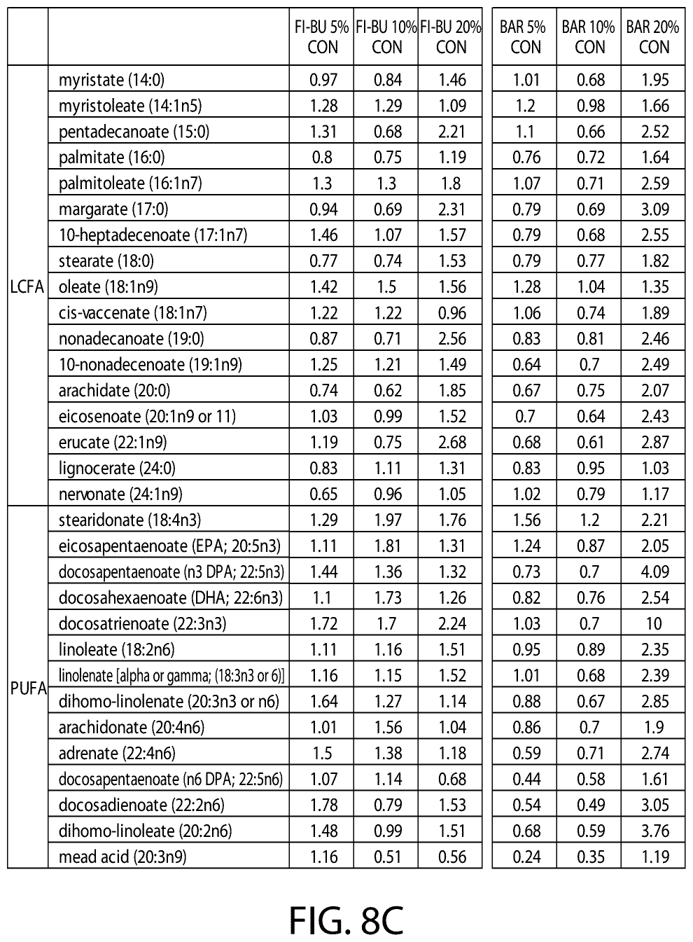

As shown in FIG. 8, several types of grain diets induced the levels of amino acids in cat fecal samples. In particular, cat fed with the 20% quinoa diet had some amino acids that show 5-fold difference compared to the control group.

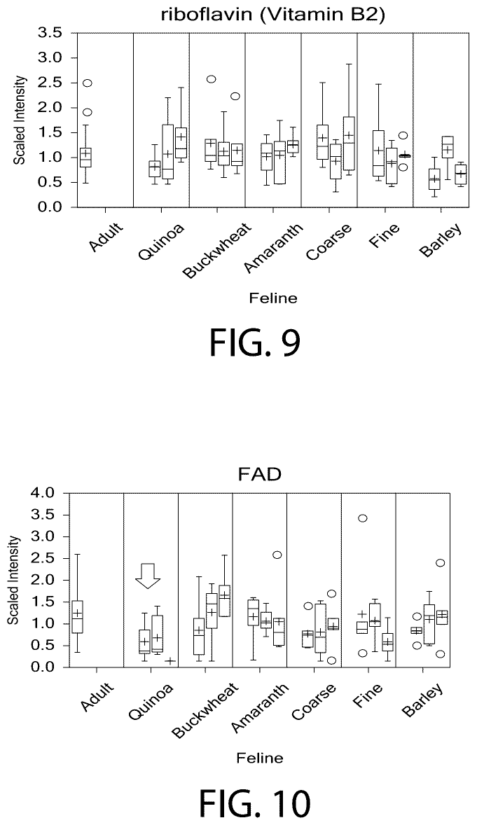

As shown in FIG. 9, the quinoa diet (10%) led to decreased levels of fatty acids in cat. In addition, the barley diet (20%) led to increased levels of fatty acids in cats. FIG. 9 also shows that cats fed with the coarse bulghur diet demonstrated significant changes in lipid metabolism. Cats fed with the 20% coarse bulghur diet had increased levels of LCFA and PUFA relative to the controls, suggesting that coarse bulghur may impact lipid absorption, catabolism or secretion in cats.

As shown in FIG. 10, cats fed with the quinoa diet had increased levels of riboflavin (vitamin B2) and decreased levels of FAD. FAD levels were decreased by 50% in quinoa 5 % group and by 88% in quinoa 20% groups relative to the control group, suggesting that Quinoa may impact FAD metabolism, which may further affect FAD dependent pathways.

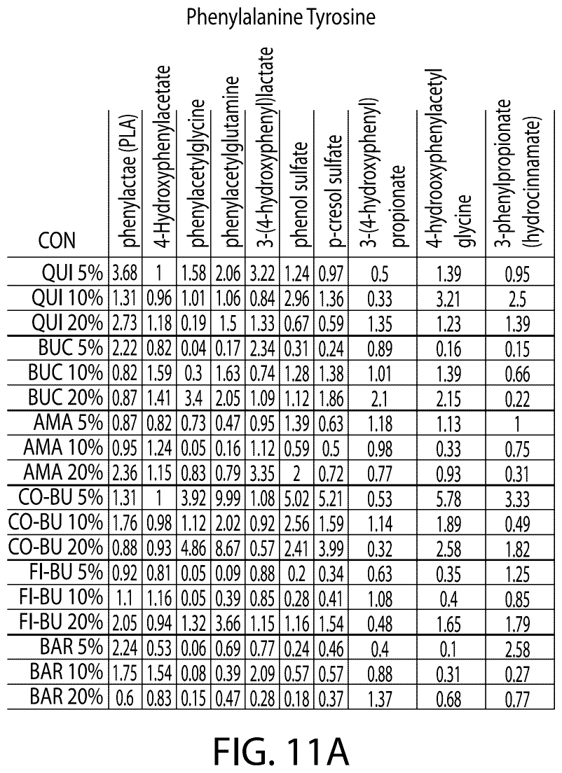

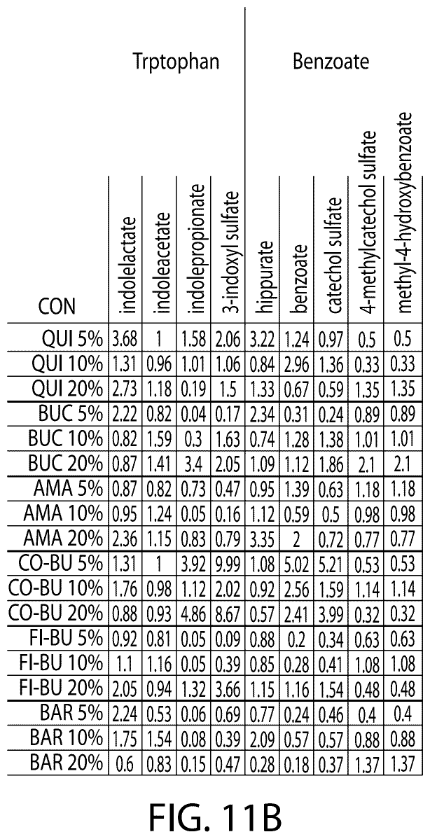

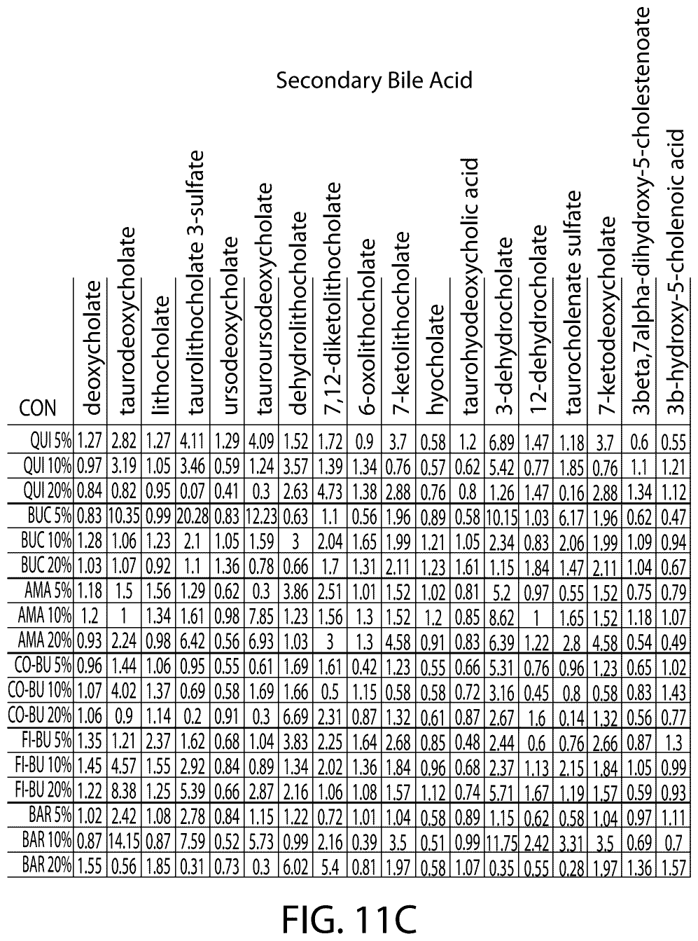

FIG. 11 lists a number of biochemicals whose metabolism may be associated with microbiome in cats. As shown in FIG. 11, different diets at different concentrations had varied effects on these biochemicals.

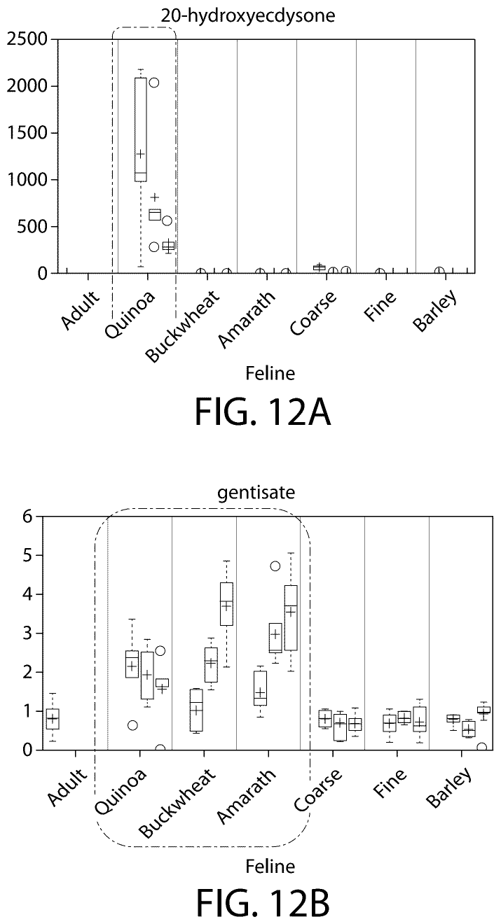

As shown in FIG. 12, cats fed with the quinoa diet had increased amounts of 20-hydroxyecdysone (200-1800 fold increases relative to the control group), which may be involved in protein synthesis and muscle enhancement. FIG. 12 also show that quinoa, buckwheat and amaranth increased the levels of gentisate, a byproduct of tyrosine and benzoate metabolism and may have anti-inflammatory, antirheumatic and antioxidant properties.

What is claimed is:

1. A method of altering one or more parameters of commensals in an animal, comprising feeding the animal a diet comprising quinoa grain in an amount effective to increase at least one of the percentage of Lactobacillus in total microbiota, the percentage of bifidobacteria in total microbiota, the percentage of Clostridium in total microbiota, or the firmicutes to bacteroidetes ratio in the animal.

2. The method of claim 1, wherein the amount of the quinoa grain is effective to increase the percentage of Lactobacillus in total microbiota.

3. The method of claim 1, wherein the amount of the quinoa grain is effective to increase the percentage of Lactobacillus in total microbiota and the percentage of bifidobacteria in total microbiota.

4. The method of claim 1, wherein the amount of the quinoa grain is effective to increase the percentage of Lactobacillus in total microbiota, the percentage of bifidobacteria in total microbiota, and the firmicutes to bacteroidetes ratio.

5. The method of claim 1, wherein the animal is a dog.

6. The method of claim 1, wherein the amount of the quinoa grain is effective to increase the percentage of Lactobacillus in total microbiota and the percentage of Clostridium in total microbiota, wherein the animal is a cat.

7. The method of claim 2, wherein the amount of quinoa grain is effective to increase the percentage of Lactobacillus in total microbiota in the animal compared to the percentage of Lactobacillus in total microbiota in the animal before the animal is fed the diet in at least an amount selected from the group consisting of 20%, 30%, 40%, 50%, 100%, 150%, and 200%.

8. The method of claim 1, wherein the amount of quinoa grain is effective to increase the percentage of bifidobacteria in total microbiota in the animal compared to the percentage of bifidobacteria in total microbiota in the animal before the animal is fed the diet in at least an amount selected from the group consisting of 50%, 60%, 70%, and 80%.

9. The method of claim 1, wherein the amount of quinoa grain is effective to increase the percentage of Clostridium in total microbiota in the animal compared to the percentage of Clostridium in total microbiota in the animal before the animal is fed the diet in at least an amount selected from the group consisting of 50%, 75%, 100%, 125%, 150% and 175%.

10. The method of claim 1, wherein the amount of quinoa grain is effective to increase the firmicutes to bacteroidetes ratio compared to the firmicutes to bacteroidetes ratio in the animal before the animal is fed the diet in at least an amount selected from the group consisting of 50%, 60%, 70%, 80%, 90%, 100%, and 110%.

11. The method of claim 1, further comprising establishing a baseline in the animal for the percentage of Lactobacillus in total microbiota, the percentage of bifidobacteria in total microbiota, the percentage of Clostridium in total microbiota, or the firmicutes to bacteroidetes ratio.

12. The method of claim 11, further comprising measuring the percentage of Lactobacillus in total microbiota, the percentage of bifidobacteria in total microbiota, the percentage of Clostridium in total microbiota, or the firmicutes to bacteroidetes ratio in the animal at one or more time points after the animal has been fed the diet comprising quinoa grain and comparing the measured amount to the baseline.

13. The method of claim 1, wherein the amount of quinoa grain is effective to increase the percentage of Lactobacillus in total microbiota, the percentage of bifidobacteria in total microbiota, the percentage of Clostridium in total microbiota, or the firmicutes to bacteroidetes ratio when the animal is fed with the diet comprising effective amount of quinoa grain for at least a period of time selected from the group consisting of: 10 days, 12 days, 14 days and 20 days.

14. A food composition comprising quinoa grain in an amount effective to increase one or more parameters of commensals in an animal when the animal consumes the food composition, wherein the one or more parameters are selected from the group consisting of the percentage of Lactobacillus in total microbiota, the percentage of bifidobacteria in total microbiota, the percentage of Clostridium in total microbiota, and firmicutes to bacteroidetes ratio.

15. The food composition of claim 14, wherein the amount of the quinoa grain is effective to increase the percentage of Lactobacillus in total microbiota, the percentage of bifidobacteria in total microbiota, and the firmicutes to bacteroidetes ratio.

16. The food composition of claim 15, wherein the animal is a dog.

17. The food composition of claim 14, wherein the amount of the quinoa grain is effective to increase the percentage of Lactobacillus in total microbiota and the percentage of Clostridium in total microbiota.

18. The food composition of claim 17, wherein the animal is a cat.

19. A method for making a pet food composition comprising the following steps:
(a) preconditioning by mixing wet and dry ingredients at elevated temperature to form a dough;
(b) extruding the dough at a high temperature and pressure to form an extruded kibble;
(c) drying the extruded kibble; and
(d) enrobing the dried kibble with topical liquid and/or dry ingredients;
wherein quinoa grain is applied to the kibble at step (a) and/or (d), in an amount effective to increase one or more parameters of commensals in an animal when the animal consumes the food composition, wherein the one or more parameters are selected from the group consisting of the percentage of Lactobacillus in total microbiota, the percentage of bifidobacteria in total microbiota, the percentage of Clostridium in total microbiota, and firmicutes to bacteroidetes ratio.

20. The method of claim 19, wherein the quinoa grain is applied at step (a) as a dry ingredient.
